(19) United States
(12) Patent Application Publication
(10) Pub. No.: US 2024/0306079 A1
(43) Pub. Date: Sep. 12, 2024

(54) Logging Different Failure Types for On-Demand System Information Request Procedures

(71) Applicant: Telefonaktiebolaget LM Ericsson (PUBL), Stockholm (SE)

(72) Inventors: Ali Parichehrehteroujeni, LINKÖPING (SE); Johan Rune, LIDINGÖ (SE); Antonino Orsino, KIRKKONUMMI (FI); Pradeepa Ramachandra, LINKÖPING (SE)

(21) Appl. No.: 18/575,134

(22) PCT Filed: Jun. 29, 2022
(86) PCT No.: PCT/SE2022/050651

§ 371 Date: Dec. 28, 2023

Related U.S. Application Data
(60) Provisional application No. 63/216,302, filed on Jun. 29, 2021.

(51) Int. Cl. H04W 48/14; H04B 17/318; H04L 1/1812; H04W 74/0833

(52) U.S. Cl. CPC H04W 48/14; H04B 17/328; H04L 1/1812; H04W 74/0833

(57) ABSTRACT

A method (800) by a wireless device (212A-D) for reporting information associated with an on demand System Information, SI, request includes transmitting (802), to a network node (210A-B), information associated with the on-demand SI request. The information indicates whether or not the on-demand SI request was successful.

### TECHNICAL FIELD

The present disclosure relates, in general, to wireless communications and, more particularly, systems and methods for logging different failure types for on-demand System Information (SI) request procedures.

### BACKGROUND

On-Demand system information (SI) acquisition is specified as part of the 3GPP TS 38.331 v. 16.4.0, which discloses in Section 5.2.2 that System Information Blocks (SIBs) can be broadcasted or not broadcasted. When the SIBs are broadcasted, si-BroadcastStatus will be set to broadcasting and the periodicity of the broadcasted SIB is provided as part of si-BroadcastStatus.

When the SI is not broadcasted, there are two methods for the user equipment (UE) to request for the SI of interest. The first method is a message1 (MSG1) based system information request. According to this method, the si-BroadcastStatus for the SIB type will be set to notbroadcasting and, if the UE is interested to read at least one SIB, the UE should follow the si-RequestConfig to figure out what Random Access Channel (RACH) resources should be used to inform the network to broadcast the required SIB. However, the si-RequestConfig is an optional field and exists if the RACH resources are configured for the SI request from the UE. Conversely, if the si-RequestConfig does not exist, or RACH resources are configured for the on demand SI request, the UE may use the second method, which is a message3 (MSG3) based system information request. In that scenario, the UE initiates the RRCSystemInfoRequest to request the SI of interest from the network.

In both methods for requesting SI, a RACH procedure should be initiated (either based on the configuration provided in MSG1-based method, or a contention-based method for MSG3-based solution). If the Random Access (RA) procedure is successful, an ra-Report will be logged by UE. The ra-Report indicates the RA procedure performance. The content of the RA procedure is disclosed in 3GPP TS 38.331. Specifically, procedures for connected mode on-demand SI requests are disclosed in Sections 5.2.2.3.5 and 5.2.2.3.6 of 3GPP TS 38.331. However, if the UE fails in random access procedure for requesting the system information, there is no action on the UE to log the failed random-access related information.

There currently exist certain challenge(s), however. For example, according to 3GPP TS 38.321 v. 16.4.0, upon triggering an on-demand request for SI (e.g., SIB) whose broadcast status is set to notbroadcasting, if the RACH resources are provided as part of si-RequestConfig, the UE shall receive an acknowledge message from lower layers. For example, the UE may receive an acknowledgement from the Medium Access Control (MAC) layer, as specified in 3GPP TS 38.321. The acknowledgement from the lower layer may trigger the acquiring of the requested on demand SI/SIB as defined in sub-clause 5.2.2.3.2 of 3GPP TS 38.331.

However, there might be different conditions that result in a UE failing to receive the requested SI. For example, in a first case, an on-demand SI/SIB request may fail due to issues concerning transmission of the preamble and reception of the Random Access Response (RAR) messages at MAC layer. For example, the UE may not be in a location with good coverage in uplink and, thus, fail in the transmission of the preamble dedicated to the on-demand SI/SIB request. As another example, the preamble may be successfully sent by UE and received by the network node, but the network node may fail in sending the RAR message due to a downlink coverage issue.

As another example, in a second case, the UE may succeed in sending the preamble and receiving the RAR indicating that the network node received the transmitted preamble. However, the UE may not be able to acquire the requested on-demand SI/SIB due to the coverage issues. Alternatively, the UE may not get the SI/SIB that the UE has requested because the network decided to not send it either via broadcast or via dedicated RRC signaling. In any of these scenarios, however, the network has no knowledge of these types of failure types.

### SUMMARY

Certain aspects of the disclosure and their embodiments may provide solutions to these or other challenges. For example, methods and systems are provided that use a new set of information logged by the UE concerning on-demand SI/SIB request procedure. The new set of information logged and reported by the UE to the RAN node (and/or to the OAM) enables the RAN node or the OAM to analyze and understand whether the failure in the procedure is originated from the MAC layer (transmission of preamble or reception of the RAR and SI request acknowledgment) or the failure occurred after reception of the SI request acknowledgment from the lower layer and at the phase of acquiring the SIB or SI message.

According to certain embodiments, a method by a wireless device for reporting information associated with an on demand SI request includes transmitting, to a network node, information associated with the on-demand SI request. The information indicates that the on-demand SI request was successful or that the on-demand SI request was not successful.

According to certain embodiments, a wireless device for reporting information associated with an on demand SI request is adapted to transmit, to a network node, information associated with the on-demand SI request. The information indicates that the on-demand SI request was successful or that the on-demand SI request was not successful.

According to certain embodiments, a method by a network node for processing information associated with an on-demand SI request includes receiving information associated with the on-demand SI request of a wireless device. The information indicates that the on-demand SI request was successful or that the on-demand SI request was not successful.

According to certain embodiments, a network node for processing information associated with an on-demand SI request is adapted to receive information associated with the on-demand SI request of a wireless device. The information indicates that the on-demand SI request was successful or that the on-demand SI request was not successful.

Certain embodiments may provide one or more of the following technical advantage(s). For example, certain embodiments may provide a technical advantage of enabling a network node or the Operations and Maintenance (OAM) that receives the measurement and information concerning an on-demand SI/SIB request to figure out whether the issue causing the failure in the procedure is related to the lower layer acquiring the SIB or SI messages. Specifically, for example, the network node or OAM may determine whether the failure is related to the MAC layer of the RRC layer. Thus, certain embodiments may provide a technical advantage of enabling the network to take a counteraction such as, for example, optimizing the MAC layer or the request procedure for acquiring SI. For example, if the information indicates that the wireless device failed in successfully transmitting the preamble or receiving the RAR procedure, the network node may need to reoptimize the SSB downlink/uplink coverage. However, if the failure occurred at the phase of acquiring the SIB or SI messages, the network node may optimize SI broadcast or unicast procedure.

As another example, certain embodiments may provide a technical advantage of enabling a wireless device to log and report to the network if the wireless device listens to the SI windows to acquire the SIB or SI messages before the actual transmission of the preamble. Knowing if the wireless device listens to the SI window before sending preamble helps the network node to optimize broadcasting of SI messages. In fact, if there are many wireless devices who check the SI window before sending the preamble, then for every preamble that the network node received, it might be better to broadcast the SIB or SI messages over all beams. This increases the chance of the other UEs receiving the SIB or SI messages before requesting it. However, if the wireless devices do not listen to the SI window before sending preamble, the network does not need to broadcast the SIB or SI messages on all the beams as other wireless devices may not listen to it.

Other advantages may be readily apparent to one having skill in the art. Certain embodiments may have none, some, or all of the recited advantages.

### BRIEF DESCRIPTION OF DRAWINGS

For a more complete understanding of the disclosed embodiments and their features and advantages, reference is now made to the following description, taken in conjunction with the accompanying drawings, in which:

FIG. 1 illustrates various network actions that are based upon wireless device behavior, according to certain embodiments;

FIG. 2 illustrates an example communication system, according to certain embodiments;

FIG. 3 illustrates an example UE, according to certain embodiments;

FIG. 4 illustrates an example network node, according to certain embodiments;

FIG. 5 illustrates a block diagram of a host, according to certain embodiments;

FIG. 6 illustrates a virtualization environment in which functions implemented by some embodiments may be virtualized, according to certain embodiments;

FIG. 7 illustrates a host communicating via a network node with a UE over a partially wireless connection, according to certain embodiments;

FIG. 8 illustrates a method by a wireless device for reporting information associated with an on demand SI/SIB request, according to certain embodiments; and

FIG. 9 illustrates a method by a network node for processing information associated with an on-demand SI/SIB request, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNodeB (MeNB), a network node belonging to a Master Cell Group (MCG) or Secondary Cell Group (SCG), base station (BS), multi-standard radio (MSR) radio node such as MSR BS, eNodeB (eNB), gNodeB (gNB), network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services UE (ProSe UE), vehicle-to-vehicle UD (V2V UE), vehicle-to-anything UE (V2X UE), etc.

Additionally, terminologies such as base station/gNB and UE should be considered non-limiting and do in particular not imply a certain hierarchical relation between the two; in general, “gNB” could be considered as device 1 and “UE” could be considered as device 2 and these two devices communicate with each other over some radio channel. And in the following the transmitter or receiver could be either gNB, or UE.

The embodiments described herein are applicable to both Long Term Evolution (LTE) and New Radio (NR) Radio Access Network (RAN) nodes.

The prohibition timer described herein is mapped to the timer T350 in 3GPP TS 38.331 and vice versa.

According to certain embodiments, network node and RAN node are used interchangeably. A non-limiting example of a network node or a RAN node can be an eNB, gNB, gNB-Central Unit (gNB-CU), gNB-CU-Control Plane (gNB-CU-CP), gNB-Distributed Unit (gNB-DU).

The term “on-demand SI” is used herein, but it is recognized that the term can also be exchanged without any loss of meaning with “on-demand SIB”, “on-demand SIBs”, or “on-demand SIB(s).” In general, “SI”, “SIB”, “SIBs”, and “SIB(s)” can be used interchangeably without any loss of meaning. According to certain embodiments, methods executed by a wireless device such as, for example a UE, are provided. The method includes logging, by the wireless device, information related to an action by the wireless device upon receiving a request for acquiring on-demand SI/SIBs. According to various particular embodiments, the wireless device may log any one or more of the following information:
an indication indicating whether the on-demand SI/SIB request has been successful or not (wherein, successful means that the UE sent the request and that the UE received the requested SIB or SI messages from the network);
an indication of whether the acknowledgement for SI request has been received from the lower layer (wherein, as used herein, the term lower layer includes a Physical (PHY) layer, a Medium Access Control (MAC) layer, or a Radio Link Control (RLC) layer);
an indication indicating whether acquiring the SIB or SI message has been failed while the acknowledgement for SIB or SI request has been received correctly from the lower layer;
an indication indicating whether acquiring the SIB or SI message has been successful while the acknowledgement for SIB or SI request has NOT been received from the lower layer;
an indication that the UE requested SIBx, SIBy, and SIBz, but the UE received only SIBx (or another SIB that is less than all of the requested SIBs);
an indication of whether the UE has checked the SI window for the needed SIB(s) or SI message(s) before initiating the on-demand SIB/SI request procedure;
an indication of how many SI window occasions were monitored by UE to receive the SIB or SI message;
an indication of how many attempts were made by the UE to receive a requested SI message, where a downlink scheduling allocation addressed to the SI-RNTI was received in an SI window pertaining to the concerned SI message;
in case the UE used the DedicatedSIBRequest RRC message to request SI in RRC_CONNECTED state, the number of HARQ retransmissions the UE made when transmitting the DedicatedSIBRequest message;
an indication of whether the UE received, from lower layers, an acknowledgement from the Hybrid Automatic Repeat Request (HARQ) procedure in the case of SI request using the DedicatedSIBRequest RRC message in RRC_CONNECTED state or a RRCSystemInfoRequest; and/or
an indication on whether the UE received the acknowledgement from the RLC lower layer in response to the transmission by the UE in RRC_CONNECTED or the DedicatedSIBRequest message for requesting on-demand SI/SIB(s).

According to certain embodiments, the wireless device logs any of the above information as part of an existing UE report such as, for example, a Connection Establishment Failure (CEF) report, RACH report, or RA report. Alternatively, the information may be logged and provided as a new report that is dedicated to providing information and measurements concerning the on-demand SI/SIB request.

Alternatively, according to a particular embodiment, the wireless device stores the information in a structure that is different from the report format and the wireless device may use the stored information to construct a report when the UE is triggered such as, for example, when the UE receives a request from the network to send a report concerning all or a part of the logged/stored information.

According to a particular embodiment, the wireless device logs the radio link quality received from the SSB beams providing the coverage for the wireless device when acquiring the requested SI/SIBs. In a further particular embodiment, the logged information related to the radio link quality may include one or more of the Reference Signal Received Power (RSRP), Reference Signal Received Quality (RSRQ), Signal Interference to Noise Ratio (SINR), Signal to Noise Ratio (SNR), Received Signal Strength Indicator (RSSI), pathloss, etc. Additionally or alternatively, the logged information may include location information at the time when the wireless device initiated the on-demand SI/SIB request.

According to certain other embodiments, the wireless device reports the radio link quality measurement of the serving and neighbouring cells measurements as part of the on-demand SI/SIB request related report. In a particular embodiment, for example, the logged information related to the radio link quality may include one or more of the RSRP, RSRQ, SINR, SNR, RSSI, pathloss, etc. Additionally or alternatively, the information may include location information for the wireless device at the time when the wireless device initiated the on-demand SI/SIB request.

In a particular embodiment, the wireless device logs the cell ID of the cell in which the SI/SIB request is performed. The cell ID may include cell global identity (CGI), and/or physical cell identity (PCI) and the operating frequency information of the cell. The UE may also log the tracking area code and Public Land Mobile Network (PLMN) identity of the cells in which the on-demand SI/SIB messages are requested, in various particular embodiments.

In a particular embodiment, the wireless device may also log the GNSS location information (e.g. obtained via Global Positioning System (GPS), Galileo, Global Navigation Satellite System (GLONASS), or Beidou) at the time when the wireless device initiated the on-demand SI/SIB request. Optionally, the location information may be complemented by information about the wireless device's speed and/or movement direction.

In particular embodiments, after logging the information and measurement concerning an on-demand SI/SIB request, the wireless device indicates the availability of the corresponding report to the network such as, for example, to a network node. Upon reception of a fetching request from network, the wireless device signals the report including the information and measurement concerning the on demand SI/SIB request to the network.

In a particular embodiment, the report including the measurement and information concerning the on-demand SI/SIB request is forwarded among the Radio Access Network (RAN) nodes via inter RAN node signaling over inter-RAN node interfaces such as Xn, NG and F1 interfaces. Thus, the network nodes may transmit/forward/exchange with each other the information received from the wireless device.

In a particular embodiment, in a report containing feedback information related to on-demand SI/SIB requests, such as a RACH report in LTE or an RA report in NR, a CEF report or a report dedicated for this purpose, i.e. an SI request report, a UE may include information indicating all the SIB(s) of the other SI that the UE is interested in and needs to receive. This would include both SIB(s) that is/are broadcast in the cell and SIB(s) that is/are not broadcast. This information can be useful for the network when determining which SIBs of the other SI that should be broadcast and which should be available on-demand. As one option, the information indicates which of the SIB(s) of the other SI the UE is interested in of the ones that are available (either broadcast or available on-demand) in the cell. As another option, the information may also indicate that the UE is interested in one or more SIB(s) specified as belonging to the other SI, which are not available (neither through broadcast nor on-demand) in the cell, e.g. the SIB(s) of the other SI that the UE is interested in out of all SIB(s) that are specified as other SI SIBs in the 3^{rd} Generation Partnership Project (3GPP) standard, or in a certain release of the 3GPP standard.

### Signaling to the Network

According to certain embodiments, the wireless device logs some, all, or any of the above-mentioned information and measurements either in an existing report, e.g., RACH report or RA report (such as the RA-Report-r16 IE in NR), or in a dedicated report purposefully designed for on-demand SI/SIB request, e.g. a new IE denoted as SI-RequestReport or SI-RequestReport-r17.

In a particular embodiment, the wireless device logs a list (of up to X number) of plurality of chunks of on-demand SI/SIB request related information and/or measurement results and/or or a set of on-demand SI/SIB request related parameters or IEs in a dedicated report or an existing report (which is extended with this new type of information).

Upon logging the information pertinent to the on-demand SI/SIB request, the wireless device indicates the availability of the report including the on-demand SI/SIB request related information to the network node and a network node requests to fetch the report via a solicitation mechanism such as, for example, the UE Information Request/Response procedure.

In a particular embodiment, the network node may not wait for the availability signal from the wireless device, and upon receiving a request for on-demand SI (i.e., the DedicatedSIBRequest message) from a wireless device in RRC_CONNECTED state, the network may initiate fetching the information pertinent to the on-demand SI request using, for example, the UE Information Request/Response procedure.

Yet, in another particular embodiment, upon sending the request for on-demand SI/SIB, the wireless device includes, by default, the report including the on-demand SI/SIB request related information of the previous on-demand SI/SIB request. For instance, if a wireless device has requested SI/SIB in RRC_IDLE or RRC_INACTIVE state and later transitions to RRC_CONNECTED state, the wireless device sends the report (without a preceding request) to the network (e.g. a gNB or an eNB) after the RRC connection has been established.

In some embodiments, if the report including the information concerning the on-demand SI Request is fetched by a RAN node (e.g., gNB-CU_2) different from the RAN node that the SI was primarily requested from (e.g. if the SI request was transmitted in a cell owned by another RAN node (e.g., gNB-CU_1), the RAN node receiving the report (including measurement results and information concerning the on-demand SI request (gNB-CU_2)) shall forward the report to the RAN node (gNB-CU_1) to which the on-demand SI/SIB request has been performed. The report may be transmitted over an inter RAN node interface such as Xn or NG interfaces, in particular embodiments.

In other embodiments, the RAN node receiving the report (e.g. gNB-CU_2), in th above-described scenario, may instead send the report to the O&M system. The O&M system may in turn process the report and initiate actions in the RAN node which is concerned with the information in the report (e.g. gNB-CU_1). Alternatively, the O&M system may forward the report to the concerned RAN node (e.g. gNB-CU_1) and let the ran node itself process the report and initiate possible actions, in a particular embodiment.

In a particular embodiment, if the gNB-DU is the one to decide and optimize the MAC layer procedures, the gNB-CU that receives the report including the on-demand SI Request related information (directly from the wireless device or from another node, e.g. another gNB-CU or an entity in the O&M system) can forward the report (or part of the report) to the gNB-DU over the F1 interface.

### Processing of On-Demand SI/SIB Request Information at Network Nodes

According to certain embodiments, the network uses feedback information related to on-demand SI/SIB requests from UEs to optimize relevant and related aspects of the network. In particular, a network node that receives the on-demand SI/SIB request related measurement results and information uses this report to optimize the SI/SIB transmissions. Thus, the network may use received such received information to optimize, adapt, tune, modify, or change configuration related aspects. For example, according to various particular embodiments, the network node may perform any one or more of the following:
Change how SIBs are grouped into different SI messages; For instance, in a particular embodiment, if the network notices that it is common that the same wireless device requests a certain set of SIBs, possibly in successive SI requests, the network may choose to change the SIB to SI message mapping so that the concerned SIBs are included in the same SI message.
Change whether a SIB/SI message is broadcast or not: For instance, in a particular embodiment, if the network notices that a certain SIB or SI message is often requested and of interest to many wireless devices, the network may choose the change the delivery principle of the concerned SI/SIB message from on-demand to broadcast.
Change the amount of Physical Random Access Channel (PRACH) resources dedicated for SI/SIB request: For instance, in a particular embodiment, if the network notices that SI/SIB requests often fail, this may be a sign of frequent collisions or that more Msg1 based SI/SIB requests are transmitted in the same PRACH occasions than the receiving base station (e.g. gNB) can handle, this may imply that it may be beneficial to increase the amount of PRACH resources, e.g. making the PRACH occasions dedicated for SI/SIB requests denser.
Change the RA related configuration associated with the SI/SIB requests: For example, in various embodiments, the network may change one or more of:
   the parameters controlling the initial transmission power,
   the power ramping step, and
   the maximum allowed number of preamble transmissions.
Change the mapping of random access preambles to SI/SIB messages for Msg1 based SI/SIB request: For instance, in a particular embodiment, the network node may choose to associate the same random access preamble with multiple SI/SIB messages which previously had separate associated random access preambles, so that these SI/SIB messages can be requested with a single Msg1 based SI/SIB request (i.e. a single random access preamble). This may be useful, for example, if the network notices that when a wireless device requests one of these SI/SIB messages, it is common that it also request the other of the concerned SI/SIB message(s).
Change from Msg1 based to Msg3 based SI/SIB request
Change which SI/SIB messages are available via Msg1 based and Msg3: In a possible future scenario where Msg1 based and Msg3 based SI request can be supported in parallel, change which SI/SIBs are available via Msg1 based and Msg3 based SI/SIB request (if they are not all requestable via both methods).
Change the number of times, or the time period, a requested SI message is broadcast: For instance, in a particular embodiment, if the feedback information reported from wireless devices indicate that the wireless device often fails to receive the requested SI message(s) or wanted SIB(s), despite having received an acknowledgement on the SI/SIB request, the network may try to address this by increasing the number of times it broadcasts a certain on-demand SI/SIB message after receiving a request for it.
Change the scheduling periodicity of on-demand SI/SIBs
Change the number of times an on-demand SI message is sent: In a particular embodiment, the network may change the number of times an on-demand SI/SIB message is sent (or beam swept) within its associated SI window (i.e. the number of times it is transmitted during the same occurrence, or instance, of its associated repetitive SI window).
The beams in which a requested SI/SIB message is transmitted: For instance, in particular embodiments, the network may change the beams in which a requested SI/SIB message is transmitted as follows:
   only the one corresponding to the Synchronization Signal Block (SSB) beam of the SSB associated with the PRACH occasion (and preamble if multiple SSBs are associated with the same PRACH occasion) that was used for the request;
   all SSB beams, i.e. an entire beam sweep; or
   a set of SSB beams within whose coverage areas statistics have shown that wireless devices are mostly located in.
Change the mapping between SIBs and SI messages; and/or
Change the length of the SI window.

In a particular embodiment, the network node classifies the failure occurred in the procedure of on-demand SI/SIB request and determines whether the failure was caused at the MAC layer (e.g., not receiving the acknowledgement for SI/SIB request at MAC layer) or whether the failure occurred after receiving the acknowledgement from the MAC layer (such as for example, the RRC layer not receiving the SI/SIB messages at SI windows).

In another particular embodiment, network node analyzes the beam index selected and used by the wireless devices to send the preamble for on-demand SI/SIB request. Network node can use this information to optimize broadcasting of the requested SI/SIB messages only over the beams selected by the wireless devices. So the network node does not broadcast the requested SI/SIB messages on the beams that were not selected by the wireless devices for transmission of the preamble.

In another embodiment if the wireless device does not provide the selected beam index but logs and provide the preamble index, first figure out which SSB is used for transmission of the selected preamble and then optimize the SI message broadcast. In other words, network node first figure out the selected beams from the selected preamble index and then broadcast the SIB or SI messages only on the beams that were frequently used by the wireless devices (or does not broadcast the SIB or SI messages on the beams that were not used by the wireless devices for request of SIB or SI messages).

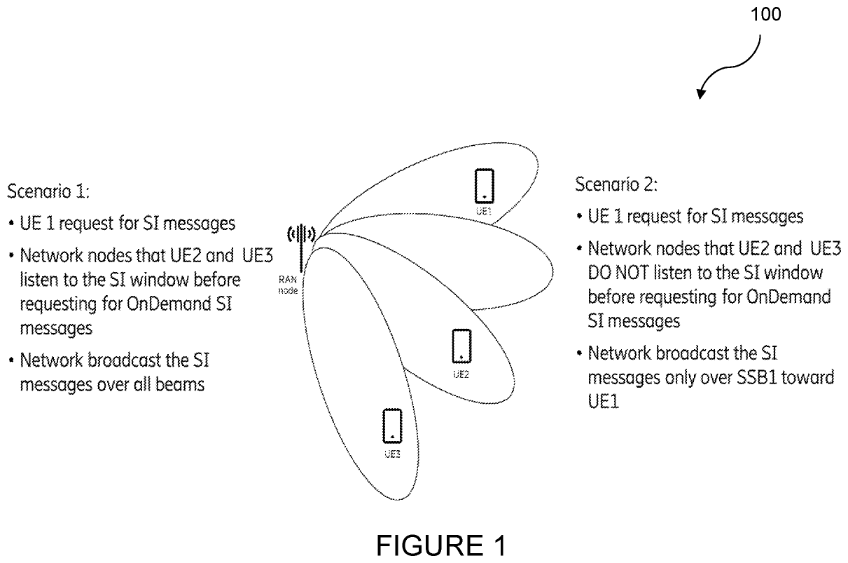

In yet another embodiment, the network node uses the information provided by the wireless device. In particular, the network node may use the wireless device behavior in checking the SI windows before sending the preamble. FIG. 1 illustrates two scenarios 100 demonstrating different network actions determined based upon wireless device behavior, according to certain embodiments.

In a first scenario (Scenario 1) illustrated in FIG. 1, the network node (i.e., RAN node) broadcasts SIB or SI messages over all beams since the wireless devices indicated that the wireless devices listen to the nearest SI window before requesting on-demand SI. For example, if the wireless devices check the SI windows and try to acquire a SIB whose broadcast status flag is set to notbroadcasting before sending the preamble, the network node can learn to broadcast the SIB or SI messages on all the beams (scenario 1 described below in FIG. 1). This increases the chance for the wireless devices to acquire a SIB whose broadcast status flag is set to notbroadcasting before the actual request. However, if the wireless devices do not check the SI windows before sending the preamble for SIB/SI request, the network node can learn to only broadcast the requested SIB or SI message on the beams that it actually received the preamble, because the other UEs covered by the other beams may not hear the broadcasted SIB or SI message until they actually request. Accordingly, in a second scenario (Scenario 2), the RAN node broadcast SIB or SI messages only toward the beam covering UE1, as the UEs indicated that they do not listen to the nearest SI window before requesting on-demand SI.

### Implementation Examples

Certain embodiments described herein include the logging and reporting of measurement results and information concerning on-demand SI request and can be implemented as part of a UE information request/response procedure (described in terms of ASN.1 code and associated field descriptions and conditional presence code explanations) in the RRC specification 3GPP TS 38.331. Three non-limiting implementation/realization examples are provided below; however, it is recognized that these examples are non-limiting and are provided only as examples embodiments.

### Example 1

In this example implementation, or realization, the ASN.1 code relies on the introduction of a new Information Element (IE) for the purpose of reporting feedback information from a UE to a gNB regarding SI/SIB request procedures the UE has been involved in (where the new IE is denoted as SI-RegeustReport-r17). The most relevant parts of the ASN.1 code are shown in bold. This code does not include all the example information items that have been described previously and the code also discloses examples of SI request related feedback information that a UE may report to the network that may not have been disclosed in the text above.

### UE-MeasurementsAvailable Information Element

-- ASN1START
-- TAG-UE-MeasurementsAvailable-START

| | | |
|---|---|---|
| UE-MeasurementsAvailable-r16 ::= | SEQUENCE { | |
| logMeasAvailable-r16 | ENUMERATED {true} | OPTIONAL, |
| logMeasAvailableBT-r16 | ENUMERATED {true} | OPTIONAL, |
| logMeasAvailableWLAN-r16 | ENUMERATED {true} | OPTIONAL, |
| connEstFailInfoAvailable-r16 | ENUMERATED {true} | OPTIONAL, |
| rlf-InfoAvailable-r16 | ENUMERATED {true} | OPTIONAL, |

```
  ...
  [[
```

| | | |
|---|---|---|
| si-RequestInfoAvailable-r17 | ENUMERATED {true} | OPTIONAL, |

```
  ]]
}
-- TAG-UE-MeasurementsAvailable-STOP
-- ASN1STOP
- UEInformationRequest
The UEInformationRequest message is used by the network to retrieve information from the UE.
Signalling radio bearer: SRB1
  RLC-SAP: AM
  Logical channel: DCCH
  Direction: Network to UE
```

UEInformationRequest message

```
-- ASN1START
-- TAG-UEINFORMATIONREQUEST-START
UEInformationRequest-r16 ::= SEQUENCE {
  rrc-TransactionIdentifier RRC-TransactionIdentifier,
  criticalExtensions CHOICE {
    ueInformationRequest-r16 UEInformationRequest-r16-IEs,
    criticalExtensionsFuture SEQUENCE { }
  }
}
UEInformationRequest-r16-IEs ::= SEQUENCE {
```

| | |
|---|---|
| idleModeMeasurementReq-r16 ENUMERATED {true} | OPTIONAL, -- |

Need N

| | |
|---|---|
| logMeasReportReq-r16 ENUMERATED {true } | OPTIONAL, -- Need N |
| connEstFailReportReq-r16 ENUMERATED {true} | OPTIONAL, -- Need |

N

| | | |
|---|---|---|
| ra-ReportReq-r16 | ENUMERATED {true} | OPTIONAL, -- Need N |
| rlf-ReportReq-r16 | ENUMERATED {true} | OPTIONAL, -- Need N |

| | |
|---|---|
| mobilityHistoryReportReq-r16 ENUMERATED {true} | OPTIONAL, -- Need |

N

| lateNonCriticalExtension OCTET STRING | | OPTIONAL, |
|---|---|---|
| nonCriticalExtension | UEInformationRequest-v1700-IEs | OPTIONAL |

}
UEInformationRequest-v1700-IEs ::= SEQUENCE {

| | |
|---|---|
| si-RequestReportReq-r17 ENUMERATED {true} | OPTIONAL, -- |

Need N

| | |
|---|---|
| nonCriticalExtension SEQUENCE { } | OPTIONAL |

}
-- TAG-UEINFORMATIONREQUEST-STOP
-- ASN1STOP

UEInformationRequest-IEs field descriptions

connEstFailReportReq
This field is used to indicate whether the UE shall report information
about the connection failure.
idleModeMeasurementReq
This field indicates that the UE shall report the idle/inactive
measurement information, if available, to the network in the
UEInformationResponse message.
logMeasReportReq
This field is used to indicate whether the UE shall report information
about logged measurements.
mobilityHistoryReportReq
This field is used to indicate whether the UE shall report information
about mobility history information.
ra-ReportReq
This field is used to indicate whether the UE shall report information
about the random access procedure.
rlf-ReportReq
This field is used to indicate whether the UE shall report information
about the radio link failure.
siRequestReportReq
This field is used to indicate whether the UE shall report information
about SI request procedures.

### UEInformationResponse

The UEInformationResponse message is used by the UE to transfer information requested by the network.

Signalling radio bearer: SRB1 or SRB2 (when logged measurement information is included)
RLC-SAP: AM
Logical channel: DCCH
Direction: UE to network

### UEInformationResponse Message

-- ASN1START
-- TAG-UEINFORMATIONRESPONSE-START
UEInformationResponse-r16 ::= SEQUENCE {
rrc-TransactionIdentifier RRC-TransactionIdentifier,

| | |
|---|---|
| criticalExtensions | CHOICE { |

ueInformationRequest-r16 UEInformationRequest-r16-IEs,

| | |
|---|---|
| criticalExtensionsFuture | SEQUENCE { } |

}
}
UEInformationResponse-r16-IEs ::= SEQUENCE {

| | |
|---|---|
| measResultIdleEUTRA-r16 MeasResultIdleEUTRA-r16 | OPTIONAL, |
| measResultIdleNR-r16 MeasResultIdleNR-r16 | OPTIONAL, |
| logMeasReport-r16 LogMeasReport-r16 | OPTIONAL, |
| connEstFailReport-r16 ConnEstFailReport-r16 | OPTIONAL, |
| ra-ReportList-r16 RA-ReportList-r16 | OPTIONAL, |
| rlf-Report-r16 RLF-Report-r16 | OPTIONAL, |
| mobilityHistoryReport-r16 MobilityHistoryReport-r16 | OPTIONAL, |
| lateNonCriticalExtension OCTET STRING | OPTIONAL, |
| nonCriticalExtension UEInformationResponse-v1700-IEs | OPTIONAL |

}

| LogMeasReport-r16 ::= | SEQUENCE { | |
|---|---|---|
| absoluteTimeStamp-r16 | AbsoluteTimeInfo-r16, | |
| traceReference-r16 | TraceReference-r16, | |
| traceRecordingSessionRef-r16 | OCTET STRING (SIZE (2)), | |
| tce-Id-r16 | OCTET STRING (SIZE (1)), | |
| logMeasInfoList-r16 | LogMeasInfoList-r16, | |
| logMeasAvailable-r16 | ENUMERATED {true} | OPTIONAL, |
| logMeasAvailableBT-r16 | ENUMERATED {true} | OPTIONAL, |
| logMeasAvailableWLAN-r16 | ENUMERATED {true} | OPTIONAL, |

...
}

| | |
|---|---|
| LogMeasInfoList-r16 ::= | SEQUENCE (SIZE (1..maxLogMeasReport-r16)) OF |

LogMeasInfo-r16

| LogMeasInfo-r16 ::= | SEQUENCE { | |
|---|---|---|
| locationInfo-r16 | LocationInfo-r16 | OPTIONAL, |
| relativeTimeStamp-r16 | INTEGER (0..7200), | |
| servCellIdentity-r16 | CGI-Info-Logging-r16 | OPTIONAL, |
| measResultServingCell-r16 | MeasResultServingCell-r16 | OPTIONAL, |

| | |
|---|---|
| measResultNeighCells-r16 | SEQUENCE { |

| | |
|---|---|
| measResultNeighCellListNR MeasResultListLogging2NR-r16 | OPTIONAL, |
| measResultNeighCellListEUTRA MeasResultList2EUTRA-r16 | OPTIONAL |

},

| anyCellSelectionDetected-r16 | ENUMERATED {true} | OPTIONAL, |
|---|---|---|
| ... | | |
| } | | |
| ConnEstFailReport-r16 ::= | SEQUENCE { | |
| measResultFailedCell-r16 | MeasResultFailedCell-r16 | |
| locationInfo-r16 | LocationInfo-r16 | OPTIONAL, |
| measResultNeighCells-r16 | SEQUENCE { | |
| measResultNeighCellListNR | MeasResultList2NR-r16 | OPTIONAL, |
| measResultNeighCellListEUTRA | MeasResultList2EUTRA-r16 | OPTIONAL, |

},

| | |
|---|---|
| numberOfConnFail-r16 | INTEGER (1..8), |
| perRAInfoList-r16 | PerRAInfoList-r16, |
| timeSinceFailure-r16 | TimeSinceFailure-r16, |

...
}

| | |
|---|---|
| MeasResultServingCell-r16 ::= | SEQUENCE { |
| resultsSSB-Cell | MeasQuantityResults, |
| resultsSSB | SEQUENCE{ |
| best-ssb-Index | SSB-Index |
| best-ssb-Results | MeasQuantityResults, |
| numberOfGoodSSB | INTEGER (1..maxNrofSSBs-r16) |
| } | OPTIONAL |

}

| | |
|---|---|
| MeasResultFailedCell-r16 ::= | SEQUENCE { |
| cgi-Info | CGI-Info-Logging-r16, |
| measResult-r16 | SEQUENCE { |
| cellResults-r16 | SEQUENCE{ |
| resultsSSB-Cell-r16 | MeasQuantityResults |

},

| | |
|---|---|
| rsIndexResults-r16 | SEQUENCE{ |
| resultsSSB-Indexes-r16 | ResultsPerSSB-IndexList |

```
    }
  }
}
RA-ReportList-r16 ::= SEQUENCE (SIZE (1..maxRAReport-r16)) OF RA-Report-r16
```

| | |
|---|---|
| RA-Report-r16 ::= | SEQUENCE { |
| cellId-r16 | CHOICE { |
| cellGlobalId-r16 | CGI-Info-Logging-r16 |
| pci-arfcn-r16 | SEQUENCE { |
| physCellId-r16 | PhysCellId, |
| carrierFreq-r16 | ARFCN-ValueNR |

```
    }
  },
```

| | | |
|---|---|---|
| ra-InformationCommon-r16 | RA-InformationCommon-r16 | OPTIONAL, |

| | |
|---|---|
| raPurpose-r16 | ENUMERATED {accessRelated, beamFailureRecovery, |

reconfigurationWithSync, ulUnSynchronized,

schedulingRequestFailure, noPUCCHResourcesAvailable,

requestForOtherSI,

spare9, spare8, spare7, spare6, spare5, spare4, spare3, spare2,

spare1},
...
}

| | |
|---|---|
| RA-InformationCommon-r16 ::= | SEQUENCE { |
| absoluteFrequencyPointA-r16 | ARFCN-ValueNR, |
| locationandBandwidth-r16 | INTEGER (0..37949), |
| subcarrierSpacing-r16 | SubcarrierSpacing, |
| msg1-FrequencyStart-r16 | INTEGER (0..maxNrofPhysicalResourceBlocks-1) |

OPTIONAL,

| | |
|---|---|
| msg1-FrequencyStartCFRA-r16 | INTEGER (0..maxNrofPhysicalResourceBlocks-1) |

OPTIONAL,

| | | |
|---|---|---|
| msg1-SubcarrierSpacing-r16 | SubcarrierSpacing | OPTIONAL, |
| msg1-SubcarrierSpacingCFRA-r16 | SubcarrierSpacing | OPTIONAL, |
| msg1-FDM-r16 | ENUMERATED {one, two, four, eight} | OPTIONAL, |

| | |
|---|---|
| msg1-FDMCFRA-r16 | ENUMERATED {one, two, four, eight} |

OPTIONAL,

| | |
|---|---|
| perRAInfoList-r16 | PerRAInfoList-r16, |

...
}
PerRAInfo-r16 ::= SEQUENCE (SIZE (1..200) OF PerRAInfo-r16

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfoList-r16 |

}

| | |
|---|---|
| perRASSBInfo-r16 ::= | SEQUENCE { |
| ssb-Index-r16 | SSB-Index, |

numberOfPreamblesSentOnSSB-r16 INTEGER (1..200),

| | |
|---|---|
| perRAAttemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |

numberOfPreamblesSentOnCSI-RS-r16 INTEGER (1..200),
}

| PerRAAttemptInfoList-r16 ::= | SEQUENCE (SIZE (1..200)) OF PerRAAttemptInfo-r16 | |
|---|---|---|
| PerRAAttemptInfo-r16 ::= | SEQUENCE { | |
| contentionDetected-r16 | BOOLEAN | OPTIONAL, |
| dlRSRPAboveThreshold-r16 | BOOLEAN | OPTIONAL, |

...
}

| RLF-Report-r16 ::= | CHOICE { | |
|---|---|---|
| nr-RLF-Report-r16 | SEQUENCE { | |
| measResultLastServCell-r16 | MeasResultRLFNR-r16, | |
| measResultNeighCells-r16 | SEQUENCE { | |
| measResultListNR-r16 | MeasResultList2NR-r16 | OPTIONAL, |
| measResultListEUTRA-r16 | MeasResultList2EUTRA-r16 | OPTIONAL |

| | |
|---|---|
| } | OPTIONAL, |
| c-RNTI-r16 | RNTI-Value, |
| previousPCellId-r16 | CHOICE { |
| nrPreviousCell-r16 | CGI-Info-Logging-r16 |
| eutraPreviousCell-r16 | CGI-InfoEUTRALogging |
| } | OPTIONAL, |
| failedPCellId-r16 | CHOICE { |
| nrFailedPCellId-r16 | CHOICE { |
| cellGlobalId-r16 | CGI-Info-Logging-r16, |
| pci-arfcn-r16 | SEQUENCE { |
| physCellId-r16 | PhysCellId |
| carrierFreq-r16 | ARFCN-ValueNR |

```
        }
      },
```

| | |
|---|---|
| eutraFailedPCellId-r16 | CHOICE { |
| cellGlobalId-r16 | CGI-InfoEUTRALogging, |
| pci-arfcn-r16 | SEQUENCE { |
| physCellId-r16 | EUTRA-PhysCellId, |
| carrierFreq-r16 | ARFCN-ValueEUTRA |

```
        }
      }
    },
```

| | |
|---|---|
| reconnectCellId-r16 | CHOICE { |
| nrReconnectCellId-r16 | CGI-Info-Logging-r16, |
| eutraReconnectCellId-r16 | CGI-InfoEUTRALogging |

| | |
|---|---|
| } | OPTIONAL |

| | |
|---|---|
| timeUntilReconnection-16 | TimeUntilReconnection-16 |

OPTIONAL,

| reestablishmentCellId-r16 | CGI-Info-Logging-r16 | |
|---|---|---|
| timeConnFailure-r16 | INTEGER (0..1023) | |
| timeSinceFailure-r16 | TimeSinceFailure-r16, | |
| connectionFailureType-r16 | ENUMERATED {rlf, hof}, | |
| rlf-Cause-r16 | ENUMERATED {t310-Expiry, randomAccessProblem, rlc- | |
| MaxNumRetx, | beamFailureRecoveryFailure, lbtFailure-r16, | |
| | bh-rlfRecoveryFailure, spare2, spare1}, | |
| locationInfo-r16 | LocationInfo-r16 | OPTIONAL, |

| | |
|---|---|
| noSuitableCellFound-r16 | ENUMERATED {true} |

OPTIONAL,

| | |
|---|---|
| ra-InformationCommon-r16 | RA-InformationCommon-r16 |

```
OPTIONAL,
    ...
  },
```

| | |
|---|---|
| eutra-RLF-Report-r16 | SEQUENCE { |
| failedPCellId-EUTRA | CGI-InfoEUTRALogging, |
| measResult-RLF-Report-EUTRA-r16 | OCTET STRING, |

```
    ...
  }
}
```

| | |
|---|---|
| MeasResultList2NR-r16 ::= | SEQUENCE(SIZE (1..maxFreq)) OF MeasResult2NR-r16 |
| MeasResultList2EUTRA-r16 ::= | SEQUENCE(SIZE (1..maxFreq)) OF |

MeasResult2EUTRA-r16

| MeasResult2NR-r16 ::= | SEQUENCE { | |
|---|---|---|
| ssbFrequency-r16 | ARFCN-ValueNR | OPTIONAL, |
| refFreqCSI-RS-r16 | ARFCN-ValueNR | OPTIONAL, |

| | |
|---|---|
| measResultList-r16 | MeasResultListNR |

}

| | |
|---|---|
| MeasResultListLogging2NR-r16 ::= | SEQUENCE(SIZE (1..maxFreq)) OF |

MeasResultLogging2NR-r16

| | |
|---|---|
| MeasResultLogging2NR-r16 ::= | SEQUENCE { |
| carrierFreq-r16 | ARFCN-ValueNR, |
| measResultListLoggingNR-r16 | MeasResultListLoggingNR-r16 |

}

| | |
|---|---|
| MeasResultListLoggingNR-r16 ::= | SEQUENCE (SIZE (1..maxCellReport)) OF |

MeasResultLoggingNR-r16

| | |
|---|---|
| MeasResultLoggingNR-r16 ::= | SEQUENCE { |
| physCellId-r16 | PhysCellId, |
| resultsSSB-Cell-r16 | MeasQuantityResults, |
| numberofGoodSSB-r16 | INTEGER (1..maxNrofSSBs-r16) OPTIONAL |

}

| | |
|---|---|
| MeasResult2EUTRA-r16 ::= | SEQUENCE { |
| carrierFreq-r16 | ARFCN-ValueEUTRA, |
| measResultList-r16 | MeasResultListEUTRA |

}

| MeasResultRLFNR-r16 ::= | SEQUENCE { | |
|---|---|---|
| measResult-r16 | SEQUENCE { | |
| cellResults-r16 | SEQUENCE { | |
| resultsSSB-Cell-r16 | MeasQuantityResults | OPTIONAL, |
| resultsCSI-RS-Cell-r16 | MeasQuantityResults | OPTIONAL |

},

| rsIndexResults-r16 | SEQUENCE{ | |
|---|---|---|
| resultsSSB-Indexes-r16 | ResultsPerSSB-IndexList | OPTIONAL, |

| | |
|---|---|
| ssbRLMCConfigBitmap-r16 | BIT STRING (SIZE (64)) |

OPTIONAL,

| | |
|---|---|
| resultsCSI-RS-Indexes-r16 | ResultsPerCSI-RS-IndexList |

OPTIONAL,

| | |
|---|---|
| csi-rsRLMConfigBitmap-r16 | BIT STRING (SIZE (96)) |

OPTIONAL

| | |
|---|---|
| } | OPTIONAL |

}
}
TimeSinceFailure-r16 ::= INTEGER (0..172800)
MobilityHistoryReport-r16 ::= VisitedCellInfoList-r16
TimeUntilReconnection-16 ::= INTEGER (0..172800)
UEInformationResponse-v1700-IEs ::= SEQUENCE {

| | |
|---|---|
| si-RequestReportList-r17 | SI-RequestReportList-r17 |

...
}

| | |
|---|---|
| SI-RequestReportList-r17 ::= | SEQUENCE (SIZE (1..maxSIRequestReport-r17)) OF |

SI-RequestReport-r17

| | |
|---|---|
| SI-RequestReport-r17 ::= | SEQUENCE { |
| cellId-r16 | CHOICE { |
| cellGlobalId-r16 | CGI-Info-Logging-r16 |
| pci-arfcn-r16 | SEQUENCE { |
| physCellId-r16 | PhysCellId, |
| carrierFreq-r16 | ARFCN-ValueNR |

```
    }
  },
```

| | |
|---|---|
| wantedSIB-Types-r17 | SEQUENCE (SIZE (1..maxSIB)) OF SIB-Type-r17, |
| siRequestType-r17 | ENUMERATED {msg1Based, msg3Based, |

```
rrcConnectedStateRequest),
  si-RequestAttemptsPerSSB-InfoList-r17 SEQUENCE (SIZE (1..200)) OF SI-
RequestAttemptsPerSSB-Info-r17 OPTIONAL, -- Cond msg1msg3Request
  si-RRC-ConnStateConfigInfo-r17 SI-RRC-ConnStateConfigInfo-r17
OPTIONAL, -- Cond rrcConnStateRequest
  perRRC-ConnStateSI-RequestAttemptInfoList-r17 SEQUENCE (SIZE (1..maxNoOfSI-
```

RequestAttemptsRRC-ConnState) OF

PerRRC-ConnStateSI-RequestAttemptInfo-r17 OPTIONAL, --Cond

| | |
|---|---|
| | rrcConnStateRequest |
| initiationTime | InitiationTimestamp, |
| locationInfo | LocationInfo-r16 |
| outcome-r17 | Outcome-r17, |
| receivedSIB-Types-r17 | SEQUENCE (SIZE (1..maxSIB)) OF SIB-Type-r17, |
| | OPTIONAL, --Cond |
| | ackedAndSubsetOfWantedSIBsReceived |
| si-MessageReceptionInfo-r17 | SI-MessageReceptionInfo-r17 |

```
    OPTIONAL, -- Cond si-MessageReceptionAttempted
  ...
```

| | |
|---|---|
| } | ENUMERATED {sibType2, sibType3, sibType4, sibType5, |
| SIB-Type-r17 ::= | sibType6, sibType7, sibType8, sibType9, |
| | sibType10-v1610, sibType11-v1610, |
| | sibType12-v1610, sibType13-v1610, |
| | sibType14-v1610, spare3, spare2, spare1, } |
| InitiationTimestamp ::= | CHOICE { |
| preciseUTC | INTEGER (0..879609302207), |

```
  coarseUTC-HSFN-SFN-SlotSymbol CoarseUTC-HSFN-SFN-SlotSymbol,
  coarseUTC-HSFN-SFN-Slot CoarseUTC-HSFN-SFN-Slot,
  coarseUTC-HSFN-SFN CoarseUTC-HSFN-SFN,
  semiCoarseUTC-SFN-SlotSymbol SemiCoarseUTC-SFN-SlotSymbol,
  semiCoarseUTC-SFN-Slot SemiCoarseUTC-SFN-Slot,
  semiCoarseUTC-SFN SemiCoarseUTC-SFN,
  hsfn-SFN-SlotSymbol HSFN-SFN-SlotSymbol,
  hsfn-SFN-Slot HSFN-SFN-Slot,
  hsfn-SFN HSFN-SFN
  gnssTime GNSS-Time
}
CoarseUTC-HSFN-SFN-SlotSymbol ::= SEQUENCE {
```

| | |
|---|---|
| coarseUTC | INTEGER (0..268435455), |
| hsfn | INTEGER (0..1023), |
| sfn | INTEGER (0..1023), |
| slot | INTEGER (0..159), |
| symbol | INTEGER (0..13) |

}
CoarseUTC-HSFN-SFN-Slot ::= SEQUENCE {

| | |
|---|---|
| coarseUTC | INTEGER (0..268435455), |
| hsfn | INTEGER (0..1023), |
| sfn | INTEGER (0..1023), |
| slot | INTEGER (0..159) |

}
CoarseUTC-HSFN-SFN ::= SEQUENCE {

| | |
|---|---|
| coarseUTC | INTEGER (0..268435455), |
| hsfn | INTEGER (0..1023), |
| sfn | INTEGER (0..1023), |
| slot | INTEGER (0..159) |

}
SemiCoarseUTC-SFN-SlotSymbol ::= SEQUENCE {

| | |
|---|---|
| semiCoarseUTC | INTEGER (0..4294967295), |
| sfn | INTEGER (0..1023), |
| slot | INTEGER (0..159), |
| symbol | INTEGER (0..13) |

}
SemiCoarseUTC-SFN-Slot ::= SEQUENCE {

| | |
|---|---|
| semiCoarseUTC | INTEGER (0..4294967295), |
| sfn | INTEGER (0..1023), |
| slot | INTEGER (0..159) |

}
SemiCoarseUTC-SFN ::= SEQUENCE {

| | |
|---|---|
| semiCoarseUTC | INTEGER (0..4294967295), |
| sfn | INTEGER (0..1023) |

}
HSFN-SFN-SlotSymbol ::= SEQUENCE {

| | |
|---|---|
| hsfn | INTEGER (0..1023), |
| sfn | INTEGER (0..1023), |
| slot | INTEGER (0..159), |
| symbol | INTEGER (0..13) |

}
HSFN-SFN-Slot ::= SEQUENCE {

| | |
|---|---|
| hsfn | INTEGER (0..1023), |
| sfn | INTEGER(0..1023), |
| slot | INTEGER (0..159) |

}

| | |
|---|---|
| HSFN-SFN ::= | SEQUENCE { |
| hsfn | INTEGER (0..1023), |
| sfn | INTEGER (0..1023) |
| GNSS-Time ::= | SEQUENCE { |
| timeSource | CHOICE { |
| gpsTime | INTEGER (0..4398046511104), |
| galileoTime | INTEGER (0..4398046511104), |
| glonassTime | INTEGER (0..8796093022207), |
| beidouTime | INTEGER (0..4398046511104), |

},

| | | |
|---|---|---|
| leapSeconds | INTEGER (−255..256) | OPTIONAL, |

}

| Outcome-r17 ::= | CHOICE { | |
|---|---|---|
| concluded-r17 | ENUMERATED | {ackedAndAllWantedSIBsReceived, |
| | | ackedAndSubsetOfWantedSIBsReceived, |
| | | ackedAndNoWantedSIBsReceived, |
| | | maxAllowedAttemptsReachedWithoutAc |
| | | k}, |
| abandoned-r17 | ENUMERATED | {wantedSIBsReceived, |

```
  subsetOfWantedSIBsReceived,
  lossOfCoverage, rlf, cellReselection,
  spare3, spare2, spare1, ...},
```

```
  ...
}
SI-MessageReceptionInfo-r17 ::= SEQUENCE (SIZE(1..maxSI-Message) OF PerSI-
MessageReceptionInfo-r17
PerSI-MessageReceptionInfo-r17 ::= SEQUENCE {
  si-MessageNumber-r17 INTEGER (1..maxSI-Message),
  numberOfReceptionAttempts-r17 INTEGER,
  si-MessageReceptionResult-r17 ENUMERATED {success, failure},
  }
SI-RequestAttemptsPerSSBInfo-r17 ::= SEQUENCE {
  ssb-Index-r16 SSB-Index,
  numberOfSI-RequestsSentOnSSB INTEGER (1..200),
  perSI-RequestAttemptInfoList-r17 SEQUENCE (SIZE (1..200)-OF PerSI)
RequestAttemptInfo-r17,
  ...
}
PerSI-RequestAttemptInfo-r17 ::= SEQUENCE {
```

| | |
|---|---|
| contentionDetected-r16 BOOLEAN | OPTIONAL, -- Cond |

msg3Request

| dlRSRPAboveThreshold-r16 BOOLEAN | | OPTIONAL, |
|---|---|---|
| relativeTimestamp | RelativeTimestamp | OPTIONAL, |

```
  ...
}
SI-RRC-ConnStateConfigInfo-r17 ::= SEQUENCE {
  absoluteFrequencyPointA-r16 ARFCN-ValueNR,
  locationAndBandwidth-r16 INTEGER (0..37949),
  subcarrierSpacing-r16 SubcarrierSpacing,
  ...
}
PerRRC-ConnStateSI-RequestAttemptInfo-r17 ::= SEQUENCE {
  numberOfHARQ-Retransmissions-r17 INTEGER,
```

| | |
|---|---|
| relativeTimestamp | RelativeTimestamp OPTIONAL, -- In case of |
| | HARQ retransmissions, the relative timestamp |
| | indicates the time of the first transmission. |

...
}

| | |
|---|---|
| RelativeTimestamp ::= | CHOICE { |
| milliseconds | INTEGER (0..1048575), |
| slots | INTEGER (0..4194303), |
| symbols | INTEGER (0..67108863), |

...
}
-- TAG-UEINFORMATIONRESPONSE-STOP
-- ASN1STOP

UEInformationResponse-IEs field descriptions

logMeasReport
This field is used to provide the measurement results stored by the UE
associated to logged MDT.
measResultldleEUTRA
EUTRA measurement results performed during RRC_INACTIVE or
RRC_IDLE.
measResultidleNR
NR measurement results performed during RRC_INACTIVE or
RRC_IDLE.
ra-ReportList
This field is used to provide the list of RA reports that is stored by the
UE for the past up to maxRAReport-r16 number of successful random
access procedures.
rif-Report
This field is used to indicate the RLF report related contents.
SI-RequestReportList
This field contains the list of SI request reports that is stored by the
UE for the past up to maxSIRequestReport number of SI request
procedures.

SI-RequestReport field descriptions

cellID
This field indicates the cell identity of the cell in which the associated SI request procedure was performed,
either in the form of the CGI or the combination of the PCI and the carrier frequency.
coarseUTC
This field indicates the time that has elapsed since midnight between the 31^{st} of December 1899 and the 1^{st}
of January 1900 according to UTC, expressed in units of 32768 milliseconds.
contentionDetected
This field is used to indicate whether contention was detected for the transmitted preamble in the case of a
Msg3 based SI request attempt. This field is not included when the UE uses Msg1 based SI request.
dIRSRPAboveThreshold
This field is used to indicate whether the RSRP of the DL beam (SSB) associated with the SI request
attempt was above or below the threshold rsrp-ThresholdSSB in rach-ConfigCommon in the UL BWP
configuration of the UL BWP selected for the SI request procedure.
gnssTime
This field indicates the number of elapsed milliseconds since the start of the time keeping of the respective
GNSS time source.
initiationTime
This field indicates the time the SI request procedure was initiated. For Msg1 and Msg3 based SI request,
this time is the start of the first symbol of the PRACH occasion used for the random access preamble
transmission. For SI request using the DedicatedSIBReqeust message in RRC_CONNECTED state, the
indicated time is the start of the first symbol of the PUSCH transmission (the first transmission in case of
HARQ retransmissions) conveying the DedicatedSIBReqeust message. If the time representation used in
the parameter has a coarser granularity, the indicated (rounded) time should be the value that is the closest
to the actual initiation time.
locationInfo
This field contains information about the UE's location, and possibly also the UE's velocity. Ideally, it should
indicate the UE's location (and velocity when applicable) at the time at the time of initiation of the SI request
procedure, but the reported location information may also have been collected at a different time, as
indicated by the location Timestamp parameter in the commonLocationInfo IE, preferably as close to the
actual time of initiation of the SI request procedure as possible.
numberOfHARQ-Retransmissions
This field indicates the number of HARQ retransmissions that were used during an SI request attempt using
transmission of a DedicatedSIBRequest message in RRC_CONNECTED state.
numberOfSI-RequestsSentOnSSB
This field is used to indicate the total number of successive Msg1 or Msg3 based SI requests that were
transmitted using PRACH resources associated with the corresponding SS/PBCH block.
outcome
This field indicates the outcome of the SI request procedure. Presence of the field concluded indicates that
the SI request procedure either was acknowledged (by a matching RAPID field in Msg2 for a Msg1 based
SI request or a matching UE Contention Resolution ID MAC CE in a Msg4 for a Msg3 based SI request or
an RLC acknowledgement for an SI request using a DedicatedSIBRequest message) or continued until the
maximum number of SI request attempts were reached without receiving an acknowledgement. If the SI
request was acknowledged, the UE may receive all its wanted SIB(s) (i.e. the SIB(s) of the type(s) indicated
by the wantedSIB-Types field), a subset of its wanted SIBs, or none of its wanted SIB(s), respectively
indicated by the ENUMERATED values “ackedAndAllWantedSIBsReceived”,
“ackedAndSubsetOfWantedSIBsReceived”, and “ackedAndNoWantedSIBsReceived”. If the UE performed
the maximum allowed number of SI request attempts without receiving an acknowledgement, the concluded
field is set to the value “maxAllowedAttemptsReachedWithoutAck”. Presence of the field abandoned
indicates that the SI request procedure was abandoned before the maximum allowed number of attempts
were performed, even though the SI request procedure was not acknowledged. The reason for abandoning
the SI request procedure is indicated by the value provided by the field.
perRRC-ConnStateSI-RequestAttemptInfoList
This field provides detailed information about a number of successive SI request attempts performed
through transmission of the DedicatedSIBRequest message in RRC_CONNECTED state, wherein the
successive message transmissions include indications of the same requested SIBs. A single SI request
attempt may comprise a set of associated HARQ retransmissions.
perSI-RequestAttemptInfoList
This field provides detailed information about a number of successive Msg1 based or Msg3 based SI
request attempts, for which the random access preamble was sent using PRACH resources associated with
the same SS/PBCH block.
preciseUTC
This field indicates the number of milliseconds that have elapsed since midnight between the 31^{st} of
December 1899 and the 1^{st} of January 1900 according to UTC.
receivedSIB-Types
This field indicates which of the wanted SIB(s) (if any) the UE received in the case where the UE's SI
request was acknowledged (by a matching RAPID field in Msg2 for a Msg1 based SI request or a matching
UE Contention Resolution ID MAC CE in a Msg4 for a Msg3 based SI request or an RLC acknowledgement
for an SI request using a DedicatedSIBRequest message), and the UE received at least one but not all of
the SIB(s) it wanted (i.e. the SIB(s) of the type(s) indicated in the wantedSIB-Types field). This field is
present if the outcome field includes the concluded field set to the value
“ackedAndSubsetOfWantedSIBsReceived”, otherwise the field is absent.
relativeTimestamp
This field indicates the elapsed time between the time indicated by the initiation Time field and the start of
the SI request attempt the relative Timestamp field is associated with. For Msg1 based and Msg3 based SI
request attempts, the start of the SI request attempt is the start of the first symbol of the PRACH occasion
used for the random access preamble transmission. For SI request attempts using the
DedicatedSIBRequest message, the start of the SI request attempts is the start of the first symbol of the
PUSCH resources used for transmission of the DedicatedSIBRequest message. If the SI request attempt
includes HARQ retransmissions, the relative timestamp indicates the time of the start of the first
transmission.
semiCoarseUTC
This field indicates the time that has elapsed since midnight between the 31^{st} of December 1899 and the 1^{st}
of January 1900 according to UTC, expressed in units of 2048 milliseconds
si-MessageReceptionInfo
This field provides information related to the reception, or attempted reception, of requested SI message(s).
I the UE did not attempt to receive any requested SI message, this field is absent. This means that the field
is present when the outcome field includes the concluded field set to either of the values
“ackedAndAllWantedSIBsReceived”, “ackedAndSubsetOfWantedSIBsReceived” or
“ackedAndNoWantedSIBsReceived”.
si-RequestAttemptsPerSSB-InfoList
This field provides detailed information about successive sets of Msg1 based or Msg3 based SI request
attempts wherein the SI request attempts in each set use PRACH resources associated with a certain
(same) SS/PBCH block. Each such set of successive SI request attempts is contained in an si-
RequestAttemptsPerSSB-Info field.
si-RequestType
This field indicates whether the type of the SI request, i.e. Msg1 based SI request, Msg3 based SI request,
or SI request using the DedicatedSIBRequest message in RRC_CONNECTED state.
si-RRC-ConnStateConfigInfo
This field provides general configuration information that is relevant for the mechanism for SI request in
RRC_CONNECTED state.
ssb-Index
This field is used to indicate the SS/PBCH index of the SS/PBCH block corresponding to the SI request
attempt.
wantedSIB-Types
This field indicates the ones (all or a subset) of the SIBs in the requested SI message(s) the UE is
interested in (during the SI request procedure that this SI-RequestReport instance pertains to). For
instance, if SIBX, SIBY and SIBZ are included in the same SI message available on-demand, and the
wantedSIB-Types parameter in the SI-RequestReport indicates SIB types X and Y, this means that in the SI
request procedure the SI-RequestReport pertains to, the UE has requested the SI message that contains
SIBX, SIBY and SIBZ, but the UE was only interested in SIBX and SIBY, but not interested in SIBZ. (Note:
If the UE changes the wanted SIB(s) or requested SI message or SIB(s) between successive attempts, this
should be regarded as a new SI request procedure, which should be logged and reported as a new SI-
RequestReport.

SI-RRC-ConnStateConfigInfo field descriptions

absoluteFrequencyPointA
This field indicates the absolute frequency position of the reference
resource block (Common RB 0).
locationAndBandwidth
Frequency domain location and bandwidth of the bandwidth part used
for transmission of the DedicatedSIBRequest message in the SI request
procedure that this SI-RequestReport pertains to.
subcarrierSpacing
This field indicates the subcarrier spacing used for transmission of the
DedicatedSIBRequest message in the SI request procedure that this
SI-RequestReport pertains to.

| Conditional Presence | Explanation |
|---|---|
| ackedAndSubsetOfWantedSIBsReceived | The field is mandatory present when the UE's SI |
| | request was acknowledged (by a matching RAPID field |
| | in Msg2 for a Msg1 based SI request or a matching UE |
| | Contention Resolution ID MAC CE in a Msg4 for a Msg3 |
| | based SI request or an RLC acknowledgement for an SI |
| | request using a DedicatedSIBRequest message), and |
| | the UE received at least one but not all of the SIB(s) it |
| | wanted (i.e. the SIB(s) of the type(s) indicated in the |
| | wantedSIB-Types field). Hence, the field is mandatory |
| | present if the outcome field includes the concluded field |
| | set to the value |
| | “ackedAndSubsetOfWantedSIBsReceived”, otherwise |
| | the field is absent. |
| msg1msg3Request | The field is mandatory present if the SI request was |
| | performed using either the Msg1 based SI request |
| | method or the Msg3 based SI request method. |
| | Otherwise, if the SI request was performed through |
| | transmission of the DedicatedSIBRequest message, the |
| | field is absent. |
| msg3Request | The field is mandatory present if the SI request was |
| | performed using the Msg3 based SI request method, |
| | otherwise the field is absent. |
| rrcConnStateRequest | The field is mandatory present if the SI request was |
| | performed through transmission of the |
| | DedicatedSIBRequest message, otherwise the field is |
| | absent. |
| si-MessageReceptionAttempted | The field is mandatory present if the UE attempted (and |
| | either succeeded or failed) to receive at least one |
| | requested SI message. |

### —LocationInfo

The IE LocationInfo is used to transfer available detailed location information, Bluetooth, WLAN and sensor available measurement results at the UE.

### LocationInfo Information Element

-- ASN2START
-- TAG-LOCATIONINFO-START
LocationInfo-r16 ::= SEQUENCE {

| | |
|---|---|
| commonLocationInfo-r16 CommonLocationInfo-r16 | OPTIONAL, |
| bt-LocationInfo-r16 LogMeasResultListBT-r16 | OPTIONAL, |
| wlan-LocationInfo-r16 LogMeasResultListWLAN-r16 | OPTIONAL, |
| sensor-LocationInfo-r16 Sensor-LocationInfo-r16 | OPTIONAL, |

. . .
}
-- TAG-LOCATIONINFO-STOP
-- ASN1STOP

### —CommonLocationInfo

The IE CommonLocationInfo is used to transfer detailed location information available at the UE to correlate measurements and UE position information.

### CommonLocationInfo Information Element

-- ASN1START
-- TAG-COMMONLOCATIONINFO-START
gnss-TOD-msec-r16
CommonLocationInfo-r16 ::= SEQUENCE {

| | |
|---|---|
| gnss-TOD-msec-r16 OCTET STRING | OPTIONAL, |
| locationTimestamp-r16 OCTET STRING | OPTIONAL, |
| locationCoordinate-r16 OCTET STRING | OPTIONAL. |
| locationError-r16 OCTET STRING | OPTIONAL. |
| locationSource-r16 OCTET STRING | OPTIONAL, |
| velocityEstimate-r16 OCTET STRING | OPTIONAL |

}
-- TAG-COMMONLOCATIONINFO-STOP
-- ASN1STOP

CommonLocationInfo field descriptions

gnss-TOD-msec
Parameter type gnss-TOD-msec defined in TS 37.355 [49]. The first/
leftmost bit of the first octet contains the most significant bit.
locationTimeStamp
Parameter type DisplacementTimeStamp defined in TS 37.355 [49].
The first/leftmost bit of the first octet contains the most significant bit.
locationCoordinate
Parameter type LocationCoordinates defined in TS 37.355 [49]. The
first/leftmost bit of the first octet contains the most significant bit.
locationError
Parameter LocationError defined in TS 37.355 [49]. The first/leftmost
bit of the first octet contains the most significant bit.
locationSource
Parameter LocationSource defined in TS 37.355 [49]. The first/
leftmost bit of the first octet contains the most significant bit.
velocityEstimate
Parameter type Velocity defined in TS 37.355 [49]. The first/leftmost
bit of the first octet contains the most significant bit.

### Example 2

As in example 1, in this second example implementation, or realization, the ASN.1 code relies on the introduction of a new IE for the purpose of reporting feedback information from a UE to a gNB regarding SI request procedures the UE has been involved in (where the new IE is denoted as SI-RegeustReport-r17). However, inside the SI-RequestReport-r17 IE, there is more reuse of parameters related to the RA-Report-r16 IE than in example 1. The most relevant parts of the ASN.1 code are highlighted in yellow. This code does not include all the example information items that have been described previously and the code also discloses examples of SI request related feedback information that a UE may report to the network that may not have been disclosed in the text above.

### UE-MeasurementsAvailable Information Element

-- ASN1START
-- TAG-UE-MeasurementsAvailable-START

| | | |
|---|---|---|
| UE-MeasurementsAvailable-r16 ::= | SEQUENCE { | |
| logMeasAvailable-r16 | ENUMERATED {true} | OPTIONAL, |
| logMeasAvailableBT-r16 | ENUMERATED {true} | OPTIONAL, |
| logMeasAvailable WLAN-r16 | ENUMERATED {true} | OPTIONAL, |
| connEstFailInfoAvailable-r16 | ENUMERATED {true} | OPTIONAL, |
| rlf-InfoAvailable-r16 | ENUMERATED {true} | OPTIONAL, |
| . . . | | |
| [[ | | |
| si-RequestInfoAvailable-r17 | ENUMERATED {true} | OPTIONAL, |
| ]] | | |
| } | | |

-- TAG-UE-MeasurementsAvailable-STOP
-- ASN1STOP

### —UEInformationRequest

The UEInformationRequest message is used by the network to retrieve information from the UE.

Signalling radio bearer: SRB1
RLC-SAP: AM
Logical channel: DCCH
Direction: Network to UE

### UEInformationRequest Message

```
-- ASN1START
-- TAG-UEINFORMATIONREQUEST-START
UEInformationRequest-r16 ::=  SEQUENCE {
  rrc-TransactionIdentifier  RRC-TransactionIdentifier,
  criticalExtensions  CHOICE {
ueInformationRequest-r16  UEInformationRequest-r16-IEs,
criticalExtensionsFuture  SEQUENCE { }
}
}
```

| | |
|---|---|
| UEInformationRequest-r16-IEs ::= SEQUENCE { | |
| idleModeMeasurementReq-r16 ENUMERATED {true} | OPTIONAL, -- |
| Need N | |
| logMeasReportReq-r16 ENUMERATED {true} | OPTIONAL, -- Need N |
| connEstFailReportReq-r16 ENUMERATED {true} | OPTIONAL, -- Need |
| N | |
| ra-ReportReq-r16 ENUMERATED {true} | OPTIONAL, -- Need N |
| rlf-ReportReq-r16 ENUMERATED {true} | OPTIONAL, -- Need N |
| mobilityHistoryReportReq-r16 ENUMERATED {true} | OPTIONAL, -- Need |
| N | |
| lateNonCriticalExtension OCTET STRING | OPTIONAL, |
| nonCriticalExtension UEInformationRequest-v1700-IEs | OPTIONAL |
| } | |
| UEInformationRequest-v1700-IEs ::= SEQUENCE { | |
| si-RequestReportReq-r17 ENUMERATED {true} | OPTIONAL, -- |
| Need N | |
| nonCriticalExtension SEQUENCE { } | OPTIONAL |
| } | |

-- TAG-UEINFORMATIONREQUEST-STOP
-- ASN1STOP

UEInformationRequest-IEs field descriptions

connEstFailReportReq
This field is used to indicate whether the UE shall report
information about the connection failure.
idleModeMeasurementReq
This field indicates that the UE shall report the idle/inactive
measurement information, if available, to the network in the
UEInformationResponse message.
logMeasReportReq
This field is used to indicate whether the UE shall report
information about logged measurements.
mobilityHistoryReportReq
This field is used to indicate whether the UE shall report
information about mobility history information.
ra-ReportReq
This field is used to indicate whether the UE shall report
information about the random access procedure.
rlf-ReportReq
This field is used to indicate whether the UE shall report
information about the radio link failure.
siRequestReportReq
This field is used to indicate whether the UE shall report
information about SI request procedures.

### UEInformationResponse

The UEInformationResponse message is used by the UE to transfer information requested by the network.

Signalling radio bearer: SRB1 or SRB2 (when logged measurement information is included)
RLC-SAP: AM
Logical channel: DCCH
Direction: UE to network

### UEInformationResponse Message

```
-- ASN1START
-- TAG-UEINFORMATIONRESPONSE-START
UEInformationResponse-r16 ::=  SEQUENCE {
  rrc-TransactionIdentifier  RRC-TransactionIdentifier,
  criticalExtensions  CHOICE {
    ueInformationResponse-r16  UEInformationResponse-r16-IEs,
    criticalExtensionsFuture  SEQUENCE { }
  }
}
UEInformationResponse-r16-IEs ::=  SEQUENCE {
  measResultIdleEUTRA-r16  MeasResultIdleEUTRA-r16  OPTIONAL,
  measResultIdleNR-r16  MeasResultIdleNR-r16  OPTIONAL,
  logMeasReport-r16  LogMeasReport-r16  OPTIONAL,
  connEstFailReport-r16  ConnEstFailReport-r16  OPTIONAL,
  ra-ReportList-r16  RA-ReportList-r16  OPTIONAL,
  rlf-Report-r16  RLF-Report-r16  OPTIONAL,
  mobilityHistoryReport-r16  MobilityHistoryReport-r16  OPTIONAL,
  lateNonCriticalExtension  OCTET STRING  OPTIONAL,
  nonCriticalExtension  UEInformationResponse-v1700-IEs  OPTIONAL
}
LogMeasReport-r16 ::=  SEQUENCE {
  absoluteTimeStamp-r16  AbsoluteTimeInfo-r16,
  traceReference-r16  TraceReference-r16,
  traceRecordingSessionRef-r16  OCTET STRING (SIZE (2)),
  tce-Id-r16  OCTET STRING (SIZE (1)),
  logMeasInfoList-r16  LogMeasInfoList-r16,
  logMeasAvailable-r16  ENUMERATED {true}  OPTIONAL,
  logMeasAvailableBT-r16  ENUMERATED {true}  OPTIONAL,
  logMeasAvailable WLAN-r16  ENUMERATED {true}  OPTIONAL,
  . . .
}
LogMeasInfoList-r16 ::=  SEQUENCE (SIZE (1..maxLogMeasReport-r16)) OF
LogMeasInfo-r16
LogMeasInfo-r16 ::=  SEQUENCE {
  locationInfo-r16  LocationInfo-r16  OPTIONAL,
  relativeTimeStamp-r16  INTEGER (0..7200),
  servCellIdentity-r16  CGI-Info-Logging-r16  OPTIONAL,
  measResultServingCell-r16  MeasResultServingCell-r16  OPTIONAL,
  measResultNeighCells-r16  SEQUENCE {
    measResultNeighCellListNR  MeasResultListLogging2NR-r16  OPTIONAL,
    measResultNeighCellEUTRA  MeasResultList2EUTRA-r16  OPTIONAL
  },
  anyCellSelectionDetected-r16  ENUMERATED {true}  OPTIONAL,
  . . .
}
ConnEstFailReport-r16 ::=  SEQUENCE {
  measResultFailedCell-r16  MeasResultFailedCell-r16,
  locationInfo-r16  LocationInfo-r16  OPTIONAL,
  measResultNeighCells-r16  SEQUENCE {
    measResultNeighCellListNR  MeasResultList2NR-r16  OPTIONAL,
    measResultNeighCellListEUTRA  MeasResultList2EUTRA-r16  OPTIONAL,
  },
  numberOfConnFail-r16  INTEGER (1..8),
  perRAInfoList-r16  PerRAInfoList-r16,
  timeSinceFailure-r16  TimeSinceFailure-r16,
  . . .
}
MeasResultServingCell-r16 ::=  SEQUENCE {
  resultsSSB-Cell  MeasQuantityResults,
  resultsSSB  SEQUENCE{
    best-ssb-Index  SSB-Index,
    best-ssb-Results  MeasQuantityResults,
    numberOfGoodSSB  INTEGER (1..maxNrofSSBs-r16)
  }  OPTIONAL
}
MeasResultFailedCell-r16 ::=  SEQUENCE {
  cgi-Info  CGI-Info-Logging-r16,
  measResult-r16  SEQUENCE {
    cellResults-r16  SEQUENCE{
      resultsSSB-Cell-r16  MeasQuantityResults
    },
    rsIndexResults-r16  SEQUENCE{
      resultsSSB-Indexes-r16  ResultsPerSSB-IndexList
    }
  }
}
RA-ReportList-r16 ::= SEQUENCE (SIZE (1..maxRAReport-r16)) OF RA-Report-r16
RA-Report-r16 ::=  SEQUENCE {
  cellId-r16  CHOICE {
    cellGlobalId-r16  CGI-Info-Logging-r16,
    pci-arfcn-r16  SEQUENCE {
      physCellId-r16  PhysCellId,
      carrierFreq-r16  ARFCN-ValueNR
    }
  },
  ra-InformationCommon-r16  RA-InformationCommon-r16  OPTIONAL,
  ra-Purpose-r16  ENUMERATED (accessRelated, beamFailureRecovery,
reconfigurationWithSync, ulUnSynchronized
```

| | |
|---|---|
| | schedulingRequestFailure, noPUCCHResourceAvailable, |
| requestForOtherSI, | |
| | spare9, spare8, spare7, spare6, spare5, spare4, spare3, spare2, |

```
spare1},
. . .
}
RA-InformationCommon-r16 ::=  SEQUENCE {
  absolutedFrequencyPointA-r16  ARFCN-ValueNR,
  locationAndBandwidth-r16  INTEGER (0..37949),
  subcarrierSpacing-r16  SubcarrierSpacing,
  msg1-FrequnceyStart-r16  INTEGER (0..maxNrofPhysicalResourceBlocks-1)
OPTIONAL,
  msg1-FrequencyStartCFRA-r16  INTEGER (0..maxNrofPhysicalResourceBlocks-1)
OPTIONAL,
  msg1-SubcarrierSpacing-r16  SubcarrierSpacing  OPTIONAL,
  msg1-SubcarrierSpacingCFRA-r16  SubcarrierSpacing  OPTIONAL,
  msg1-FDM-r16  ENUMERATED {one, two, four, eight}  OPTIONAL,
  msg1-FDMCFRA-r16  ENUMERATED {one, two, four, eight}
OPTIONAL,
  perRAInfoList-r16  PerRAInfoList-r16,
  . . .
}
PerRaInfoList-r16 ::= SEQUENCE (SIZE (1..200)) OF PerRAInfo-r16
PerRAInfo-r16 ::=  CHOICE {
  perRASSBInfoList-r16  PerRASSBInfo-r16,
  perRACSI-RSInfoList-r16  PerRACSI-RSInfo-r16
}
PerRASSBInfo-r16 ::=  SEQUENCE {
  ssb-Index-r16  SSB-Index,
  numberOfPreamblesSentOnSSB-r16  INTEGER (1..200),
  perRAAttemptInfoList-r16  PerRAAttemptInfoList-r16
}
PerRACSI-RSInfo-r16 ::=  SEQUENCE {
  csi-RS-Index-r16  CSI-RS-Index,
  numberOfPreambleSentOnCSI-RS-r16  INTEGER (1..200)
}
PerRAAttemptInfo-r16 ::=  SEQUENCE (SIZE (1..200)) OF PerRAAttemptInfo-r16
PerRAAttemptInfo-r16 ::=  SEQUENCE {
  contentionDetected-r160  BOOLEAN  OPTIONAL,
  dlRSRPAboveThreshold-r16  BOOLEAN  OPTIONAL,
  . . .
}
RLF-Report-r16 ::=  CHOICE {
  nr-RLF-Report-r16  SEQUENCE {
    measResultLastServCell-r16  MeasResultRLFNR-r16,
    measResultNeighCells-r16  SEQUENCE {
      measResultListNR-r16  MeasResultList2NR-r16  OPTIONAL,
      measResultListEUTRA-r16  MeasResultList2EUTRA-r16  OPTIONAL
    }  OPTIONAL,
    c-RNTI-r16  RNTI-Value,
    previousPCellID-r16  CHOICE {
      nrPreviousCell-r16  CGI-Info-Logging-r16,
      eutraPreviousCell-r16  CGI-InfoEUTRALogging
    }  OPTIONAL,
    failedPCellId-r16  CHOICE {
      nrFailedPCellId-r16  CHOICE {
        cellGlobalId-r16  CGI-Info-Logging-r16,
        pci-arfcn-r16  SEQUENCE {
          physCellId-r16  PhysCellId,
          carrierFreq-r16  ARFCN-ValueNR
        }
      },
      eutraFailedPCellId-r16  CHOICE {
        cellGlobalId-r16  CGI-InfoEUTRALogging,
        pci-arfcn-r16  SEQUENCE {
          physCellId-r16  EUTRA-PhysCellId,
          carrierFreq-r16  ARFCN-ValueEUTRA
        }
      }
    },
    reconnectCellId-r16  CHOICE {
      nrReconnectCellId-r16  CGI-Info-Logging-r16,
      eutraReconnectCellId-r16  CGI-InfoEutraLogging
    }  OPTIONAL,
    timeUntilReconnection-r16  TimeUntilReconnection-16
OPTIONAL,
    reestablishmentCellId-r16  CGI-Info-Logging-r16  OPTIONAL,
    timeConnFailure-r16  INTEGER (0..1023)  OPTIONAL,
    timeSinceFailure-r16  TimeSinceFailure-r16,
    connectionFailureType-r16  ENUMERATED {rlf, hof},
    rlf-Cause-r16  ENUMERATED {t210-Expiry, randomAccessProblem, rlc-
MaxNumRetx,
```

beamFailureRecoveryFailure, lbtFailure-r16,
bh-rlfRecoveryFailure, spare2, spare1},

```
    locationInfo-r16  LocationInfo-r16  OPTIONAL,
    noSuitableCellFound-r16  ENUMERATED {true}
OPTIONAL,
    ra-InformationCommon-r16  RA-InformationCommon-r16
OPTIONAL,
    . . .
  },
  eutra-RLF-Report-r16  SEQUENCE {
    failedPCellId-EUTRA  CGI-InfoEUTRALogging,
    measResult-RLF-Report-EUTRA-r16  OCTET STRING,
    . . .
  }
}
MeasResultList2NR-r16 ::=  SEQUENCE(SIZE (1..maxFreq)) OF MeasResult2NR-r16
MeasResultList2EUTRA-r16 ::=  SEQUENCE(SIZE (1..maxFreq)) OF
MeasResult2EUTRA-r16
MeasResult2NR-r16 ::=  SEQUENCE {
  ssbFrequency-r16  ARFCN-ValueNR  OPTIONAL,
  refFreqCSI-RS-r16  ARFCN-ValueNR  OPTIONAL,
  measResultList-r16  MeasResultListNR
}
MeasResultListLogging2NR-r16 ::=  SEQUENCE(SIZE (1..maxFreq)) OF
MeasResultLogging2NR-r16
MeasResultLogging2NR-r16 ::=  SEQUENCE {
  carrierFreq-r16  ARFCN-ValueNR,
  measResultListLoggingNR-r16  MeasResultListLoggingNR-r16
}
MeasResultListLoggingNR-r16 ::=  SEQUENCE (SIZE (1..maxCellReport)) OF
MeasResultLoggingNR-r16
MeasResultLoggingNR-r16 ::=  SEQUENCE {
  physCellId-r16  PhysCellId,
  resultSSB-Cell-r16  MeasQuantityResults,
  numberOfGoodSSB-r16  INTEGER (1..maxNrofSSbs-r16) OPTIONAL
}
MeasResult2EUTRA-r16 ::=  SEQUENCE {
  carrierFreq-r16  ARFCN-ValueEUTRA,
  MeasResultList-r16  MeasResultListEUTRA
}
MeasResultRLFNR-r16 ::=  SEQUENCE {
  measResult-r16  SEQUENCE {
    cellResults-r16  SEQUENCE{
      resultsSSB-Cell-r16  MeasQuantityResults  OPTIONAL,
      resultsCSI-RS-Cell-r16  MeasQuantityResults  OPTIONAL
    },
    rsIndexResults-r16  SEQUENCE{
      resultsSSB-Indexes-r16  ResultsPerSSB-IndexList  OPTIONAL,
      ssbRLMConfigBitmap-r16  BIT STRING (SIZE (64))
OPTIONAL,
      resultsCSI-RS-Indexes-r16  ResultsPerCSI-RS-IndexList
OPTIONAL,
      csi-rsRLMConfigBitmap-r16  BIT STRING (SIZE (96))
OPTIONAL
    }  OPTIONAL
  }
}
TimeSinceFailure-r16 ::= INTEGER (0..172800)
MobilityHistoryReport-r16 ::= VisitedCellInfoList-r16
TimeUntilReconnection-16 ::= INTEGER (0..172800)
UEInformationResponse-v1700-IEs ::=  SEQUENCE {
  si-RequestReportList-r17  SI-RequestReportList-r17
  . . .
}
SI-RequestReportList-r17 ::=  SEQUENCE (SIZE (1..maxSiRequestReport-r17)) OF
SI-RequestReport-r17
SI-RequestReport-r17 ::=  SEQUENCE {
  cellId-r16  CHOICE {
    cellGlobalId-r16  CGI-Info-Logging-r16,
    pci-arfcn-r16  SEQUENCE {
      physCellId-r16  PhysCellId,
      carrierFreq-r16  ARFCN-ValueNR
    }
  },
  wantedSIB-Types-r17  SEQUENCE (SIZE (1..maxSIB)) OF SIB-Type-r17,
  siRequestType-r17  ENUMERATED {msg1Based, msg3Based,
rrcConnectedStateRequest),
  perRAInfoList-r16  PerRAInfoList-r16  OPTIONAL, --
Cond msg1msg3Request
  si-RRC-ConnStateConfigInfo-r17  SI-RRC-ConnStateConfigInfo-r17
OPTIONAL, -- Cond rrcConnStateRequest
  perRRC-ConnStateSI-RequestAttemptInfoList-r17 SEQUENCE (SIZE (1..maxNoOfSI-
```

RequestAttemptsRRC-ConnState) OF

```
PerRRC-ConnStateSI-RequestAttemptInfo-r17 OPTIONAL, -- Cond
    rrcConnStateRequest
  initiationTime  InitiationTimestamp,
  locationInfo  LocationInfo-r16  OPTIONAL,
  outcome-r17  Outcome-r17,
  receivedSIB-Types-r17  SEQUENCE (SIZE (1..maxSIB)) OF SIB-TYPE-r17
                                    OPTIONAL, -- Cond
                                    ackedAndSubsetOfWantedSIBsReceived
  si-MessageReceptionInfo-r17  SI-MessageReceptionInfo-r17
      OPTIONAL, -- Cond si-MessageReceptionAttempted
  . . .
}
SIB-Type-r17 ::=  ENUMERATED {sibType2, sibType3, sibType4, sibType5,
```

sibType6, sibType7, sibType8, sibType9,
sibType10-v1610, sibType11-v1610,
sibType12-v1610, sibType13-v1610,
sibType14-v1610, spare3, spare2, spare1, . . . }

```
IntitiationTimestamp ::=  CHOICE {
  preciseUTC  INTEGER (0..879609322207),
  coarseUTC-HSFN-SFN-SlotSymbol  CoarseUTC-HSFN-SFN-SlotSymbol,
  coarseUTC-HSFN-SFN-Slot  CoarseUTC-HSFN-SFN-Slot,
  coarseUTC-HSFN-SFN  CoarseUTC-HSFN-SFN,
  semiCoarseUTC-SFN-SlotSymbol  SemiCoarseUTC-SFN-SlotSymbol,
  semiCoarseUTC-SFN-Slot  SemiCoarseUTC-SFN-Slot,
  semiCoarseUTC-SFN  SemiCoarseUTC-SFN,
  hsfn-SFN-SlotSymbol  HSFN-SFN-SlotSymbol,
  hsfn-SFN-Slot  HSFN-SFN-Slot,
  hsfn-SFN  HSFN-SFN,
  gnssTime  GNSS-Time
}
CoarseUTC-HSFN-SFN-SlotSymbol ::=  SEQUENCE {
  coarseUTC  INTEGER (0..268435455),
  hsfn  INTEGER (0..1023),
  sfn  INTEGER (0..1023),
  slot  INTEGER (0..159),
  symbol  INTEGER (0..13)
}
CoarseUTC-HSFN-SFN-Slot ::=  SEQUENCE {
  coarseUTC  INTEGER (0..268435455),
  hsfn  INTEGER (0..1023),
  sfn  INTEGER (0..1023),
  slot  INTEGER (0..159)
}
CoarseUTC-HSFN-SFN ::=  SEQUENCE {
  coarseUTC  INTEGER (0..268435455),
  hsfn  INTEGER (0..1023),
  sfn  INTEGER (0..1023),
  slot  INTEGER (0..159)
}
SemiCoarseUTC-SFN-SLotSymbol ::=  SEQUENCE {
  semiCoarseUTC  INTEGER (0..4294967295),
  sfn  INTEGER (0..1023),
  slot  INTEGER (0..159),
  symbol  INTEGER (0..13)
}
SemiCoarseUTC-SFN-Slot ::=  SEQUENCE {
  semiCoarseUTC  INTEGER (0..4294967295),
  sfn  INTEGER (0..1023),
  slot  INTEGER (0..159)
}
SemiCoarseUTC-SFN ::=  SEQUENCE {
  semiCoarseUTC  INTEGER (0..4294967295),
  sfn  INTEGER (0..1023)
}
HSFN-SFN-SlotSymbol ::=  SEQUENCE {
  hsfn  INTEGER (0..1023),
  sfn  INTEGER (0..1023),
  slot  INTEGER (0..159),
  symbol  INTEGER (0..13)
}
HSFN-SFN-Slot ::=  SEQUENCE {
  hsfn  INTEGER (0..1023),
  sfn  INTEGER (0..1023),
  slot  INTEGER (0..159)
}
HSFN-SFN ::=  SEQUENCE {
  hsfn  INTEGER (0..1023),
  sfn  INTEGER (0..1023)
}
GNSS-Time ::=  SEQUENCE {
  timeSource  CHOICE {
    gpsTime  INTEGER (0..4398046511104),
    galileoTime  INTEGER (0..4398046511104),
    glonassTime  INTEGER (0..8796093022207),
    beidouTime  INTEGER (0..4398046511104),
    . . .
  },
  leapSeconds  INTEGER (−255..256)  OPTIONAL,
}
Outcome-r17 ::=  CHOICE {
  concluded-r17  ENUMERATED {ackedAndAllWantedSIBsReceived,
```

ackedAndSubsetOfWantedSIBsReceived,
ackedAndNoWantedSIBsReceived,
maxAllowedAttemptsReachedWithougAc
k},

abandoned-r17 ENUMERATED {wantedSIBsReceived,

| | |
|---|---|
| | subsetOFWantedSIBsReceived, |
| | lossOfCoverage, rlf, cellReselection, |
| | spare3, spare2, spare1, . . . }, |
| . . . | |
| } | |

```
SI-MessageReceptionInfo-r17 ::=  SEQUENCE (SIZE(1..maxSI-Message) OF PerSI-
MessageReceptionInfo-r17)
PerSI-MessageReceptionInfo-r17 ::=  SEQUENCE {
  si-MessageNumber-r17  INTEGER (1..maxSI-Message),
  numberOfReceptionAttempts-r17  INTEGER,
  si-MessageReceptionResult-r17  ENUMERATED {success, failure},
  . . .
}
SI-RRC-ConnStateConfigInfo-r17 ::=  SEQUENCE {
  absoluteFrequencyPointA-r16  ARFCN-ValueNR,
  locationAndBandwidth-r16  INTEGER (0..37949),
  subcarrierSpaceing-r16  SubcarrierSpacing,
  . . .
}
PerRRC-ConnStateSI=RequestAttemptInfo-r17 ::= SEQUENCE {
  numberOfHARQ-Retransmissions-r17  INTEGER,
  relativeTimestamp  RelativeTimestamp
OPTIONAL, -- In case of HARQ retransmissions, the relative timestamp indicates
the time of the first transmission.
  . . .
}
RelativeTimeStamp ::=  CHOICE {
  milliseconds  INTEGER (0..1048575),
  slots  INTEGER (0..4194303),
  symbols  INTEGER (0..67108863),
  . . .
}
-- TAG-UEINFORMATIONRESPONSE-STOP
-- ASN1STOP
```

UEInformationResponse-IEs field descriptions

logMeasReport
This field is used to provide the measurement results stored by the UE
associated to logged MDT.
measResultIdleEUTRA
EUTRA measurement results performed during RRC_INACTIVE or
RRC_IDLE.
measResultIdleNR
NR measurement results performed during RRC_INACTIVE or
RRC_IDLE.
ra-ReportList
This field is used to provide the list of RA reports that is stored by the
UE for the past up to maxRAReport-r16 number of successful random
access procedures.
rlf-Report
This field is used to indicate the RLF report related contents.
SI-RequestReportList
This field contains the list of SI request reports that is stored by the
UE for the past up to maxSIRequestReport number of SI request
procedures.

RA-Report field descriptions

absoluteFrequencyPointA
This field indicates the absolute frequency position of the reference resource block
(Common RB 0).
cellID
This field indicates the CGI of the cell in which the associated random access procedure
was performed.
contentionDetected
This field is used to indicate that contention was detected for the transmitted preamble in
the given random access attempt or not. This field is not included when the UE performs
random access attempt is using contention free random-access resources or when the
raPurpose is set to requestForOtherSI.
csi-RS-Index
This field is used to indicate the CSI-RS index corresponding to the random access
attempt.
dlRSRPAboveThreshold
This field is used to indicate whether the DL beam (SSB) quality associated to the
random access attempt was above or below the threshold rsrp-ThresholdSSB in
beamFailureRecoveryConfig in UL BWP configuration of UL BWP selected for random
access procedure initiated for beam failure recovery; Otherwise, rsrp-ThresholdSSB in
rach-ConfigCommon in UL BWP configuration of UL BWP selected for random access
procedure.
locationAndBandwidth
Frequency domain location and bandwidth of the bandwidth part associated to the
random-access resources used by the UE.
numberOfPreamblesSentOnCSI-RS
This field is used to indicate the total number of successive RA preambles that were
transmitted on the corresponding CSI-RS.
numberOfPreamblesSentOnSSB
This field is used to indicate the total number of successive RA preambles that were
transmitted on the corresponding SS/PBCH block.
perRAAttemptInfoList
This field provides detailed information about a random access attempt.
perRAInfoList
This field provides detailed information about each of the random access attempts in the
chronological order of the random access attempts.
perRACSI-RSInfoList
This field provides detailed information about the successive random access attempts
associated to the same CSI-RS.
perRASSBInfoList
This field provides detailed information about the successive random access attempts
associated to the same SS/PBCH block.
raPurpose
This field is used to indicate the RA scenario for which the RA report entry is triggered.
The RA accesses associated to Initial access from RRC_IDLE, transition from RRC-
INACTIVE and the MSG3 based SI request are indicated using the indicator
‘accessRelated’. The indicator beamFailureRecovery is used in case of successful beam
failure recovery related RA procedure in the SpCell [3]. The indicator
reconfigurationWithSync is used if the UE executes a reconfiguration with sync. The
indicator ulUnSynchronized is used if the random access procedure is initiated in a
SpCell by DL or UL data arrival during RRC_CONNECTED when the
timeAlignmentTimer is not running in the PTAG or if the RA procedure is initiated in a
serving cell by a PDCCH order [3]. The indicator schedulingRequestFailure is used in
case of SR failures [3]. The indicator noPUCCHResourceAvailable is used when the UE
has no valid SR PUCCH resources configured [3]. The indicator requestForOtherSI is
used for MSG1 based on demand SI request.
ra-InformationCommon
This field is used to indicate the common random-access related information between
RA-report and RLF-report. For RA report, this field is mandatory presented. For RLF-
report, this field is optionally included when connectionFailureType is set to ‘hof’ or
when connectionFailureType is set to ‘rlf’ and the rlf-Cause equals to
‘randomAccessProblem’ or ‘beamRecoveryFailure’; otherwise this field is absent.
ssb-Index
This field is used to indicate the SS/PBCH index of the SS/PBCH block corresponding to
the random access attempt.
subcarrierSpacing
Subcarrier spacing used in the BWP associated to the random-access resources used by
the UE.
SI-RequestReport field descriptions
cellID
This field indicates the cell identity of the cell in which the associated SI request
procedure was performed, either in the form of the CGI or the combination of the PCI
and the carrier frequency.
coarseUTC
This field indicates the time that has elapsed since midnight between the 31^{st} of
December 1899 and the 1^{st} of January 1900 according to UTC, expressed in units of
32768 milliseconds.
contentionDetected
This field is used to indicate whether contention was detected for the transmitted
preamble in the case of a Msg3 based SI request attempt. This field is not included
when the UE uses Msg1 based SI request.
dIRSRPAboveThreshold
This field is used to indicate whether the RSRP of the DL beam (SSB) associated with
the SI request attempt was above or below the threshold rsrp-ThresholdSSB in rach-
ConfigCommon in the UL BWP configuration of the UL BWP selected for the SI
request procedure.
gnssTime
This field indicates the number of elapsed milliseconds since the start of the time
keeping of the respective GNSS time source.
initiationTime
This field indicates the time the SI request procedure was initiated. For Msg1 and Msg3
based SI request, this time is the start of the first symbol of the PRACH occasion used
for the random access preamble transmission. For SI request using the
DedicatedSIBReqeust message in RRC_CONNECTED state, the indicated time is the
start of the first symbol of the PUSCH transmission (the first transmission in case of
HARQ retransmissions) conveying the DedicatedSIBReqeust message. If the time
representation used in the parameter has a coarser granularity, the indicated (rounded)
time should be the value that is the closest to the actual initiation time.
locationInfo
This field contains information about the UE's location, and possibly also the UE's
velocity. Ideally, it should indicate the UE's location (and velocity when applicable) at
the time at the time of initiation of the SI request procedure, but the reported location
information may also have been collected at a different time, as indicated by the
locationTimestamp parameter in the commonLocationInfo IE, preferably as close to the
actual time of initiation of the SI request procedure as possible.
outcome
This field indicates the outcome of the SI request procedure. Presence of the field
concluded indicates that the SI request procedure either was acknowledged (by a
matching RAPID field in Msg2 for a Msg1 based SI request or a matching UE
Contention Resolution ID MAC CE in a Msg4 for a Msg3 based SI request or an RLC
acknowledgement for an SI request using a DedicatedSIBRequest message) or
continued until the maximum number of SI request attempts were reached without
receiving an acknowledgement. If the SI request was acknowledged, the UE may
receive all its wanted SIB(s) (i.e. the SIB(s) of the type(s) indicated by the wantedSIB-
Types field), a subset of its wanted SIBs, or none of its wanted SIB(s), respectively
indicated by the ENUMERATED values “ackedAndAllWantedSIBsReceived”,
“ackedAndSubsetOfWantedSIBsReceived”, and “ackedAndNoWantedSIBsReceived”.
If the UE performed the maximum allowed number of SI request attempts without
receiving an acknowledgement, the concluded field is set to the value
“maxAllowedAttemptsReachedWithoutAck”. Presence of the field abandoned indicates
that the SI request procedure was abandoned before the maximum allowed number of
attempts were performed, even though the SI request procedure was not acknowledged.
The reason for abandoning the SI request procedure is indicated by the value provided
by the field.
perRRC-ConnStateSI-RequestAttemptInfoList
This field provides detailed information about a number of successive SI request
attempts performed through transmission of the DedicatedSIBRequest message in
RRC_CONNECTED state, wherein the successive message transmissions include
indications of the same requested SIBs. A single SI request attempt may comprise a set
of associated HARQ retransmissions.
preciseUTC
This field indicates the number of milliseconds that have elapsed since midnight
between the 31^{st} of December 1899 and the 1^{st} of January 1900 according to UTC.
receivedSIB-Types
This field indicates which of the wanted SIB(s) (if any) the UE received in the case
where the UE's SI request was acknowledged (by a matching RAPID field in Msg2 for
a Msg1 based SI request or a matching UE Contention Resolution ID MAC CE in a
Msg4 for a Msg3 based SI request or an RLC acknowledgement for an SI request using
a DedicatedSIBRequest message), and the UE received at least one but not all of the
SIB(s) it wanted (i.e. the SIB(s) of the type(s) indicated in the wantedSIB-Types field).
This field is present if the outcome field includes the concluded field set to the value
“ackedAndSubsetOfWantedSIBsReceived”, otherwise the field is absent.
relativeTimestamp
This field indicates the elapsed time between the time indicated by the initiationTime
field and the start of the SI request attempt the relativeTimestamp field is associated
with. For Msg1 based and Msg3 based SI request attempts, the start of the SI request
attempt is the start of the first symbol of the PRACH occasion used for the random
access preamble transmission. For SI request attempts using the DedicatedSIBRequest
message, the start of the SI request attempts is the start of the first symbol of the
PUSCH resources used for transmission of the DedicatedSIBRequest message. If the SI
request attempt includes HARQ retransmissions, the relative timestamp indicates the
time of the start of the first transmission.
semiCoarseUTC
This field indicates the time that has elapsed since midnight between the 31^{st} of
December 1899 and the 1^{st} of January 1900 according to UTC, expressed in units of
2048 milliseconds
si-MessageReceptionInfo
This field provides information related to the reception, or attempted reception, of
requested SI message(s). I the UE did not attempt to receive any requested SI message,
this field is absent. This means that the field is present when the outcome field includes
the concluded field set to either of the values “ackedAndAllWantedSIBsReceived”,
“ackedAndSubsetOfWantedSIBsReceived″ or ″ackedAndNoWantedSIBsReceived”.
si-RequestType
This field indicates whether the type of the SI request, i.e. Msg1 based SI request, Msg3
based SI request, or SI request using the DedicatedSIBRequest message in
RRC_CONNECTED state.
si-RRC-ConnStateConfigInfo
This field provides general configuration information that is relevant for the mechanism
for SI request in RRC_CONNECTED state.
ssb-Index
This field is used to indicate the SS/PBCH index of the SS/PBCH block corresponding
to the SI request attempt.
wantedSIB-Types
This field indicates the ones (all or a subset) of the SIBs in the requested SI message(s)
the UE is interested in (during the SI request procedure that this SI-RequestReport
instance pertains to). For instance, if SIBX, SIBY and SIBZ are included in the same SI
message available on demand, and the wantedSIB-Types parameter in the SI-
RequestReport indicates SIB types X and Y, this means that in the SI request procedure
the SI-RequestReport pertains to, the UE has requested the SI message that contains
SIBX, SIBY and SIBZ, but the UE was only interested in SIBX and SIBY, but not
interested in SIBZ. (Note: If the UE changes the wanted SIB(s) or requested SI message
or SIB(s) between successive attempts, this should be regarded as a new SI request
procedure, which should be logged and reported as a new SI-RequestReport.

SI-RRC-ConnState ConfigInfo field descriptions

absolute FrequencyPointA
This field indicates the absolute frequency position of the reference
resource block (Common RB 0).
locationAndBandwidth
Frequency domain location and bandwidth of the bandwidth part
used for transmission of the DedicatedSIBRequest message in the
SI request procedure that this SI-RequestReport pertains to.
subcarrierSpacing
This field indicates the subcarrier spacing used for transmission of
the DedicatedSIBRequest message in the SI request procedure that
this SI-RequestReport pertains to.

| Conditional Presence | Explanation |
|---|---|
| ackedAndSubsetOfWantedSIBsReceived | The field is mandatory present when the UE's |
| | SI request was acknowledged (by a matching |
| | RAPID field in Msg2 for a Msg1 based SI |
| | request or a matching UE Contention |
| | Resolution ID MAC CE in a Msg4 for a |
| | Msg3 based SI request or an RLC |
| | acknowledgement for an SI request using a |
| | DedicatedSIBRequest message), and the UE |
| | received at least one but not all of the SIB(s) |
| | it wanted (i.e. the SIB(s) of the type(s) |
| | indicated in the wantedSIB-Types field). |
| | Hence, the field is mandatory present if the |
| | outcome field includes the concluded field set |
| | to the value |
| | “ackedAndSubsetOfWantedSIBsReceived”, |
| | otherwise the field is absent. |
| msg1msg3Request | The field is mandatory present if the SI |
| | request was performed using either the Msg1 |
| | based SI request method or the Msg3 based |
| | SI request method. Otherwise, if the SI |
| | request was performed through transmission |
| | of the DedicatedSIBRequest message, the |
| | field is absent. |
| msg3Request | The field is mandatory present if the SI |
| | request was performed using the Msg3 based |
| | SI request method, otherwise the field is |
| | absent. |
| rrcConnStateRequest | The field is mandatory present if the SI |
| | request was performed through transmission |
| | of the DedicatedSIBRequest message, |
| | otherwise the field is absent. |
| si-MessageReceptionAttempted | The field is mandatory present if the UE |
| | attempted (and either succeeded or failed) to |
| | receive at least one requested SI message. |

### —LocationInfo

The IE LocationInfo is used to transfer available detailed location information, Bluetooth, WLAN and sensor available measurement results at the UE.

### LocationInfo Information Element

-- ASN1START
-- TAG-LOCATIONINFO-START

| | |
|---|---|
| LocationInfo-r16 ::= SEQUENCE { | |
| commonLocationInfo-r16 CommonLocationInfo-r16 | OPTIONAL, |
| bt-LocationInfo-r16 LogMeasResultListBT-r16 | OPTIONAL, |
| wlan-LocationInfo-r16 LogMeasResultListWLAN-r16 | OPTIONAL, |
| sensor-LocationInfo-r16 Sensor-LocationInfo-r16 | OPTIONAL, |

. . .
}
-- TAG-LOCATIONINFO-STOP
-- ASN1STOP

### —CommonLocationInfo

The IE CommonLocationInfo is used to transfer detailed location information available at the UE to correlate measurements and UE position information.

### CommonLocationInfo Information Element

-- ASN1START
-- TAG-COMMONLOCATIONINFO-START
gnss-TOD-msec-r16
CommonLocationInfo-r16 ::= SEQUENCE {

| | |
|---|---|
| gnss-TOD-msec-r16 OCTET STRING | OPTIONAL, |
| locationTimestamp-r16 OCTET STRING | OPTIONAL, |
| locationCoordinate-r16 OCTET STRING | OPTIONAL, |
| locationError-r16 OCTET STRING | OPTIONAL, |
| locationSource-r16 OCTET STRING | OPTIONAL |
| velocityEstimate-r16 OCTET STRING | OPTIONAL |
| } | |

-- TAG-COMMONLOCATIONINFO-STOP
-- ASN1STOP

CommonLocationInfo field descriptions

gnss-TOD-msec
Parameter type gnss-TOD-msec defined in TS 37.355 [49]. The first/
leftmost bit of the first octet contains the most significant bit.
locationTimeStamp
Parameter type DisplacementTimeStamp defined in TS 37.355 [49].
The first/leftmost bit of the first octet contains the most significant bit.
locationCoordinate
Parameter type LocationCoordinates defined in TS 37.355 [49]. The
first/leftmost bit of the first octet contains the most significant bit.
locationError
Parameter LocationError defined in TS 37.355 [49]. The first/leftmost
bit of the first octet contains the most significant bit.
locationSource
Parameter LocationSource defined in TS 37.355 [49]. The first/
leftmost bit of the first octet contains the most significant bit.
velocityEstimate
Parameter type Velocity defined in TS 37.355 [49]. The first/leftmost
bit of the first octet contains the most significant bit.

The following is yet another non-limiting implementation example.

### UEInformationResponse Message

```
-- ASN1START
-- TAG-UEINFORMATIONRESPONSE-START
UEInformationResponse-r16 ::=  SEQUENCE {
  rrc-TransactionIdentifier  RRC-TransactionIdentifier,
  criticalExtensions  CHOICE {
    ueInformationResponse-r16  UEInformationResponse-r16-IEs,
    criticalExtensionsFuture  SEQUENCE { }
  }
}
UEInformationResponse-r16-IES ::=  SEQUENCE {
  measResultIdleEUTRA-r16  MeasResultIdleEUTRA-r16  OPTIONAL,
  measResultIdleNR-r16  MeasResultIdleNR-r16  OPTIONAL,
  logMeasReport-r16  LogMeasReport-r16  OPTIONAL,
  connEstFailReport-r16  ConnEstFailReport-r16  OPTIONAL,
  ra-ReportList-r17  RA-ReportList-r16  OPTIONAL,
  rlf-Report-r16  RLF-Report-r16  OPTIONAL,
  mobilityHistoryReport-r16  MoblilityHistoryReport-r16  OPTIONAL,
    SI-ReportList-r17  SI-ReportList-r17  OPTIONAL,
  lateNonCriticalExtension  OCTET STRING  OPTIONAL,
  nonCriticalExtension  SEQUENCE { }  OPTIONAL
}
SI-ReportList-r17 ::= SEQUENCE (SIZE (1..maxSIREPORT-r17)) OF SI-Report-r17
SI-Report-r17 ::=  SEQUENCE {
  cellId-r17  CHOICE {
      cellGlobalID-r17  CGI-Info-Logging-r16,
      pci-arfcn-r17  SEQUENCE {
        physCellId-r16  PhysCellId,
        carrierFreq-r16  ARFCN-ValueNR
```

| | | |
|---|---|---|
| } | | |
| }, | | |
| SuccessfulSiRequestACk-r17 | BOOLEAN | OPTIONAL, |
| SuccessfulSIAcquiring-r17 | BOOLEAN | OPTIONAL, |
| SuccessfulSIAcquiringWithAbortedRACH | BOOLEAN | |
| OPTIONAL, | | |
| ListenToNearestSIWindow | BOOLEAN | |
| OPTIONAL, | | |

```
measResultServingCell-r16  MeasResultServingCell-r16  OPTIONAL,
measResultNeighCells-r16  SEQUENCE {
      measResultNeighCellListNR MeasResultListLogging2NR-r16  OPTIONAL,
      measResultNeighCellListEUTRA  MeasResultList2EUTRA-r16
OPTIONAL
  },
  . . .
}
LogMeasReport-r16 ::=  SEQUENCE {
  absoluteTimeStamp-r16  AbsoluteTimeInfo-r16,
  traceReference-r16  TraceReference-r16
  traceRecordingSessionRef-r16  OCTET STRING (SIZE (2)),
  tce-Id-r16  OCTET STRING (SIZE (1)),
  logMeasInfoList-r16  LogMeasInfoList-r16,
  logMeasAvailable-r16  ENUMERATED {true}  OPTIONAL,
  logMeasAvailableBT-r16  ENUMERATED {true}  OPTIONAL,
  logMeasAvailableLWAN-r16  ENUMERATED {true}  OPTIONAL,
  . . .
}
LogMeasInfoList-r16 ::=  SEQUENCE (SIZE (1..maxLogMeasReport-r16)) OF
LogMeasInfo-r16
LogMeasInfro-r16 ::=  SEQUENCE {
  locationInfo-r16  LocationInfo-r16  OPTIONAL,
  relativeTimeStamp-r16  INTEGER (0..7200),
  servCellIdentity-r16  CGI-Info-Logging-r16  OPTIONAL,
  measResultServingCell-r16  MeasResultServingCell-r16  OPTIONAL,
  measResultNeighCell-r16  SEQUENCE {
    measResultNeighCellListNR  MeasResultListLogging2NR-r16  OPTIONAL,
    measResultNeighCellListEUTRA  MeasResultList2EUTRA-r16  OPTIONAL
  },
  anyCellSelectionDetected-r16  ENUMERATED {true}  OPTIONAL
}
ConnEstFailReport-r16 ::=  SEQUENCE {
  measResultFailedCell-r16  MeasResultFailedCell-r16,
  locationInfo-r16  LocationInfo-r16  OPTIONAL,
  measResultNeighCells-r16  SEQUENCE{
    measResultNeighCellListNR  MeasResultList2NR-r16  OPTIONAL,
    measResultNeighCellListEutra  MeasResultList2EUTRA-r16  OPTIONAL
  },
  numberOfConnFail-r16  INTEGER (1..8),
  perRAInfoList-r16   PerRAInfoList-r16,
  timeSinceFailure-r16  TimeSinceFailure-r16
  . . .
}
MeasResultServingCell-r16 ::=   SEQUENCE {
  resultsSSB-Cell  MeasQuantityResults,
  resultsSSB  SEQUENCE{
    best-ssb-Index  SSB-Index,
    best-ssb-Results  MeasQuantityResults,
    numberOfGoodSSB  INTEGER (1..maxNrofSSBs-r16)
}  OPTIONAL
}
MeasResultFailedCell-r16 ::=  SEQUENCE {
  cgi-Info  CGI-Info-Logging-r16,
  measResult-r16  SEQUENCE {
    cellsResults-r16  SEQUENCE {
      resultsSSB-Cell-r16  MeasQuantityResults
    },
    rsIndexResults-r16  SEQUENCE{
      resultsSSB-Indexes-r16  ResultsPerSSB-IndexList
    }
  }
}
RA-ReportList-r16 ::= SEQUENCE (SIZE (1..maxRAReport-r16)) OF RA-Report-r16
RA-Report-r16 ::=  SEQUENCE {
  cellID-r16  CHOICE {
    cellGlobalId-r16  CGI-Info-Logging-r16,
    pci-arfcn-r16  SEQUENCE {
      physCellId-r16  PhysCellId,
      carrierFreq-r16  ARFCN-ValueNR
    }
  },
  ra-InformationCommon-r16  RA-InformationCommon-r16,
  raPurpose-r16  ENUMERATED {accessRelated, beamFailureRecovery,
reconfigurationWithSync, ulUnSynchronized,
```

schedulingRequestFailure, noPUCCHResourceAvailable,

requestForOtherSI,

spare9, spare8, spare7, spare6, spare5, spare4, spare3, spare2,

```
spare1}
}
RA-InformationCommon-r16 ::=  SEQUENCE {
  absoluteFrequencyPointA-r16  ARFCN-ValueNR,
  locationAndBandwith-r16  INTEGER (0..37949),
  subcarrierSpacing-r16  SubcarrierSpacing,
  msg1-FrequencyStart-r16  INTEGER (0..maxNrofPhysicalResourceBlocks-1)
OPTIONAL,
  msg1-FrequencyStartCFRA-r16  INTEGER (0..mxNrofPhysicalResourceBlocks-1)
OPTIONAL,
  msg1-SubcarrierSpacing-r16  SubcarrierSpacing  OPTIONAL,
  msg1-SubcarrierSpacingCFRA-r16  SubcarrierSpacing  OPTIONAL,
  msg1-FDM-r16  ENUMERATED {one, two, four, eight}  OPTIONAL,
  msg1-FDMCFRA-r16  ENUMERATED {one, two, four, eight}
OPTIONAL,
  perRAInfoList-r16  PerRAInfoList-r16
}
PerRAInfoList-r16 ::= SEQUENCE (SIZE (1..200)) OF PerRAInfo-r16
PerRAInfo-r16 ::=  CHOICE {
  perRASSBInfoList-r16  PerRASSInfo-r16,
  perRACSI-RSInfoList-r16  PerRACSI-RSInfo-r16
}
PerRASSBInfo-r16 ::=  SEQUENCE {
  ssb-Index-r16  SSB-Index,
  numberOfPreambleSentOnSSB-r16  INTEGER (1..200),
  perRAAttemptInfoList-r16  PerRAAttemptedInfoList-r16
}
PerRACSI-RSInfo-r16 ::=  SEQUENCE {
  csi-RS-Index-r16  CSI-RS-Index,
  numberOfPreambleSentOnCSI-RS-r16  INTEGER (1..200)
}
PerRAAttemptInfoList-r16 ::=  SEQUENCE (SIZE (1..200)) OF PerRAAttemptInfo-r16
PerRAAtemptInfo-r16 ::=  SEQUENCE {
  contentionDetected-r16  BOOLEAN  OPTIONAL,
  dlRSRPAboveThreshold-r16  BOOLEAN  OPTIONAL,
  . . .
}
RLF-Report-r16 ::=  CHOICE {
  nr-RLF-Report-r16  SEQUENCE {
    measResultLastServCell-r16  MeasResultRLFNR-r16,
    measResultNeighCells-r16  SEQUENCE {
      measResultListNR-r16  MeasResultList2NR-r16  OPTIONAL,
      measResultListEUTRA-r16  MeasResultList2EUTRA-r16  OPTIONAL
    }  OPTIONAL
    c-RNTI-r16  RNTI-Value,
    previousPCellId-r16  CHOICE {
      nrPreviousCell-r16  CGI-Info-Logging-r16,
      eutraPreviousCell-r16  CGI-InfoEUTRALogging
    }  OPTIONAL,
    failedPCellId-r16  CHOICE {
      nrFailedPCellId-r16  CHOICE {
        cellGlobalId-r16  CGI-Info-Logging-r16,
        pci-arfcn-r16  SEQUENCE {
          physCellId-r16  PhysCellId,
          carrierFreq-r16  ARFCN-ValueNR
        }
      },
      eutraFailedPCellId-r16  CHOICE {
        cellGlobalId-r16  CGI-InfoEUTRALogging,
        pci-arfcn-r16  SEQUENCE {
          physCellId-r16  EUTRA-PhysCellId,
          carrierFreq-r16  ARFCN-ValueEUTRA
        }
      }
    },
    reconnectCellId-r16  CHOICE {
      nrReconnectCellId-r16  CGI-Info-Logging-r16,
      eutraReconnectCellId-r16  CGI-InfoEUTRALogging
    }  OPTIONAL,
    timeUntilReconnection-16  TimeUntilReconnection-16
OPTIONAL,
    reestablishmentCellId-r16  CGI-Info-Logging-r16  OPTIONAL,
    timeConnFailure-r16  INTEGER (0..1023)  OPTIONAL,
    timeSinceFailure-r16  TimeSinceFailure-r16,
    connectionFailureType-r16  ENUMERATED {rlf, hof},
    rlf-Cause-r16  ENUMERATED {t310-Expiry, randomAccessProblem, rlc-
MaxNumRetx,
```

beamFailureRecoveryFailure, lbtFailure-r16,
bh-rlfRecoveryFailure, spare2, spare1},

```
    locationInfo-r16  LocationInfo-r16  OPTIONAL,
    noSuitableCellFound-r16  ENUMERATED {true}
OPTIONAL,
    ra-InformationCommon-r16  RA-InformationCommon-r16
OPTIONAL,
    . . .
  },
  eutra-RLF-Report-r16  SEQUENCE {
    failedPCellId-EUTRA  CGI-InfoEUTRALogging,
    measResult-RLF-Report-EUTRA-r16  OCTET STRING,
    . . .
  }
}
MeasResultList2NR-r16 ::=  SEQUENCE(SIZE (1..maxFreq)) OF MeasResult2NR-r16
MeasResultList2EUTRA-r16 ::=  SEQUENCE(SIZE (1..maxFreq)) OF
MeasResult2EUTRA-r16
MeasResult2NR-r16 ::=  SEQUENCE {
  ssbFrequency-r16  ARFCN-ValueNR  OPTIONAL,
  refFreqCSI-RS-r16  ARFCN-ValueNR  OPTIONAL,
  measResultList-r16  MeasResultListNR
}
MeasResultListLogging2NR-r16 ::=  SEQUENCE(SIZE (1..maxFreq)) OF
MeasResultLogging2NR-r16
MeasResultLogging2NR-r16 ::=  SEQUENCE {
  carrierFreq-r16  ARFCN-ValueNR,
  measResultListLoggingNR-r16  MeasResultListLoggingNR-r16
}
MeasResultListLoggingNR-r16 ::=  SEQUENCE (SIZE (1..maxCellReport)) OF
MeasResultLoggingNR-r16
MeasResultLoggingNR-r16 ::=  SEQUENCE {
  physCellId-r16  PhysCellId,
  resultsSSB-Cell-r16  MeasQuantityResults,
  numberOfGoodSSB-r16  INTEGER (1..maxNrofSSBs-r16)  OPTIONAL
}
MeasResult2EUTRA-r16 ::=  SEQUENCE {
  carrierFreq-r16  ARFCN-ValueEUTRA,
  measResultList-r16  MeasResultListEUTRA
}
MeasResultRLFNR-r16 ::=  SEQUENCE {
  measResult-r16  SEQUENCE {
    cellResults-r16  SEQUENCE{
      resultsSSB-Cell-r16  MeasQuantityResults  OPTIONAL,
      resultsCSI-RS-Cell-r16  MeasQuantityResults  OPTIONAL
    },
    rsIndexResults-r16  SEQUENCE{
      resultsSSB-Indexes-r16  ResultsPerSSB-IndexList  OPTIONAL,
      ssbRLMConfigBitmap-r16  BIT STRING (SIZE (64))
OPTIONAL,
      resultsCSI-RS-Indexes-r16  ResultsPerCSI-RS-IndexList
OPTIONAL,
      csi-rsRLMConfigBitmap-r16  BIT STRING (SIZE (96))
OPTIONAL
    }  OPTIONAL
  }
}
TimeSinceFailure-r16 ::= INTEGER (0..172800)
MobilityHistoryReport-r16 ::= VisitedCellInfoList-r16
TimeUntilReconnection-16 ::= INTEGER (0..172800)
```

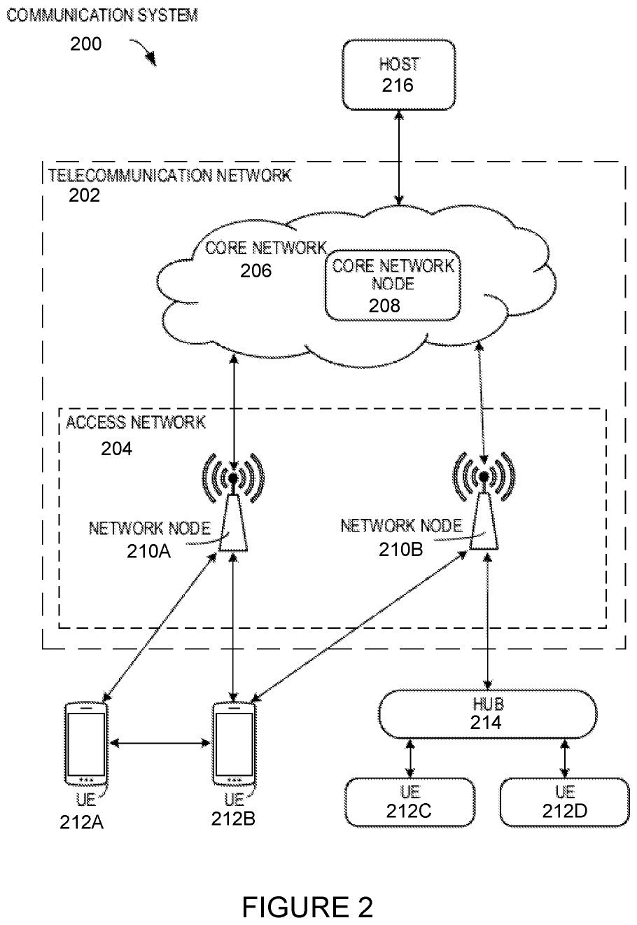

FIG. 2 shows an example of a communication system 200 in accordance with some embodiments. In the example, the communication system 200 includes a telecommunication network 202 that includes an access network 204, such as a radio access network (RAN), and a core network 206, which includes one or more core network nodes 208. The access network 204 includes one or more access network nodes, such as network nodes 210a and 210b (one or more of which may be generally referred to as network nodes 210), or any other similar 3^{rd} Generation Partnership Project (3GPP) access node or non-3GPP access point. The network nodes 210 facilitate direct or indirect connection of user equipment (UE), such as by connecting UEs 212a, 212b, 212c, and 212d (one or more of which may be generally referred to as UEs 212) to the core network 206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 200 may include any number of wired or wireless networks, network nodes, UEs, and/or any other components or systems that may facilitate or participate in the communication of data and/or signals whether via wired or wireless connections. The communication system 200 may include and/or interface with any type of communication, telecommunication, data, cellular, radio network, and/or other similar type of system.

The UEs 212 may be any of a wide variety of communication devices, including wireless devices arranged, configured, and/or operable to communicate wirelessly with the network nodes 210 and other communication devices. Similarly, the network nodes 210 are arranged, capable, configured, and/or operable to communicate directly or indirectly with the UEs 212 and/or with other network nodes or equipment in the telecommunication network 202 to enable and/or provide network access, such as wireless network access, and/or to perform other functions, such as administration in the telecommunication network 202.

In the depicted example, the core network 206 connects the network nodes 210 to one or more hosts, such as host 216. These connections may be direct or indirect via one or more intermediary networks or devices. In other examples, network nodes may be directly coupled to hosts. The core network 206 includes one more core network nodes (e.g., core network node 208) that are structured with hardware and software components. Features of these components may be substantially similar to those described with respect to the UEs, network nodes, and/or hosts, such that the descriptions thereof are generally applicable to the corresponding components of the core network node 208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 216 may be under the ownership or control of a service provider other than an operator or provider of the access network 204 and/or the telecommunication network 202, and may be operated by the service provider or on behalf of the service provider. The host 216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 200 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 202 is a cellular network that implements 3GPP standardized features. Accordingly, the telecommunications network 202 may support network slicing to provide different logical networks to different devices that are connected to the telecommunication network 202. For example, the telecommunications network 202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 212 are configured to transmit and/or receive information without direct human interaction. For instance, a UE may be designed to transmit information to the access network 204 on a predetermined schedule, when triggered by an internal or external event, or in response to requests from the access network 204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 214 communicates with the access network 204 to facilitate indirect communication between one or more UEs (e.g., UE 212c and/or 212d) and network nodes (e.g., network node 210b). In some examples, the hub 214 may be a controller, router, content source and analytics, or any of the other communication devices described herein regarding UEs. For example, the hub 214 may be a broadband router enabling access to the core network 206 for the UEs. As another example, the hub 214 may be a controller that sends commands or instructions to one or more actuators in the UEs. Commands or instructions may be received from the UEs, network nodes 210, or by executable code, script, process, or other instructions in the hub 214. As another example, the hub 214 may be a data collector that acts as temporary storage for UE data and, in some embodiments, may perform analysis or other processing of the data. As another example, the hub 214 may be a content source. For example, for a UE that is a VR headset, display, loudspeaker or other media delivery device, the hub 214 may retrieve VR assets, video, audio, or other media or data related to sensory information via a network node, which the hub 214 then provides to the UE either directly, after performing local processing, and/or after adding additional local content. In still another example, the hub 214 acts as a proxy server or orchestrator for the UEs, in particular in if one or more of the UEs are low energy IoT devices.

The hub 214 may have a constant/persistent or intermittent connection to the network node 210b. The hub 214 may also allow for a different communication scheme and/or schedule between the hub 214 and UEs (e.g., UE 212c and/or 212d), and between the hub 214 and the core network 206. In other examples, the hub 214 is connected to the core network 206 and/or one or more UEs via a wired connection. Moreover, the hub 214 may be configured to connect to an M2M service provider over the access network 204 and/or to another UE over a direct connection. In some scenarios, UEs may establish a wireless connection with the network nodes 210 while still connected via the hub 214 via a wired or wireless connection. In some embodiments, the hub 214 may be a dedicated hub—that is, a hub whose primary function is to route communications to/from the UEs from/to the network node 210b. In other embodiments, the hub 214 may be a non-dedicated hub—that is, a device which is capable of operating to route communications between the UEs and network node 210b, but which is additionally capable of operating as a communication start and/or end point for certain data channels.

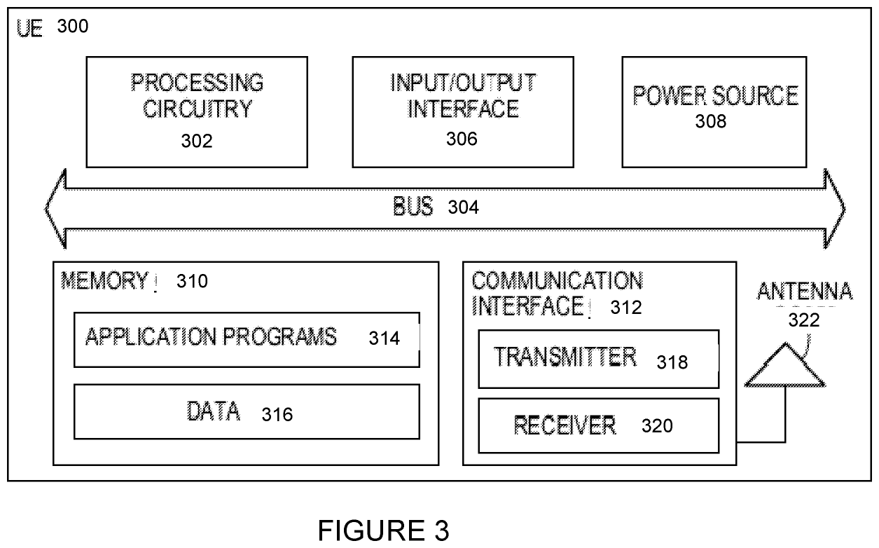

FIG. 3 shows a UE 300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 300 includes processing circuitry 302 that is operatively coupled via a bus 304 to an input/output interface 306, a power source 308, a memory 310, a communication interface 312, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 302 may include multiple central processing units (CPUs).

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the UE 300 via input circuitry or an interface such as an electrical power cable. Delivering power may be, for example, for charging of the power source 308. Power circuitry may perform any formatting, converting, or other modification to the power from the power source 308 to make the power suitable for the respective components of the UE 300 to which power is supplied.

The memory 310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the UE 300, any of a variety of various operating systems or combinations of operating systems.

The memory 310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 310 may allow the UE 300 to access instructions, application programs and the like, stored on transitory or non-transitory memory media, to off-load data, or to upload data. An article of manufacture, such as one utilizing a communication system may be tangibly embodied as or in the memory 310, which may be or comprise a device-readable storage medium.

The processing circuitry 302 may be configured to communicate with an access network or other network using the communication interface 312. The communication interface 312 may comprise one or more communication subsystems and may include or be communicatively coupled to an antenna 322. The communication interface 312 may include one or more transceivers used to communicate, such as by communicating with one or more remote transceivers of another device capable of wireless communication (e.g., another UE or a network node in an access network). Each transceiver may include a transmitter 318 and/or a receiver 320 appropriate to provide network communications (e.g., optical, electrical, frequency allocations, and so forth). Moreover, the transmitter 318 and receiver 320 may be coupled to one or more antennas (e.g., antenna 322) and may share circuit components, software or firmware, or alternatively be implemented separately.

In the illustrated embodiment, communication functions of the communication interface 312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 300 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

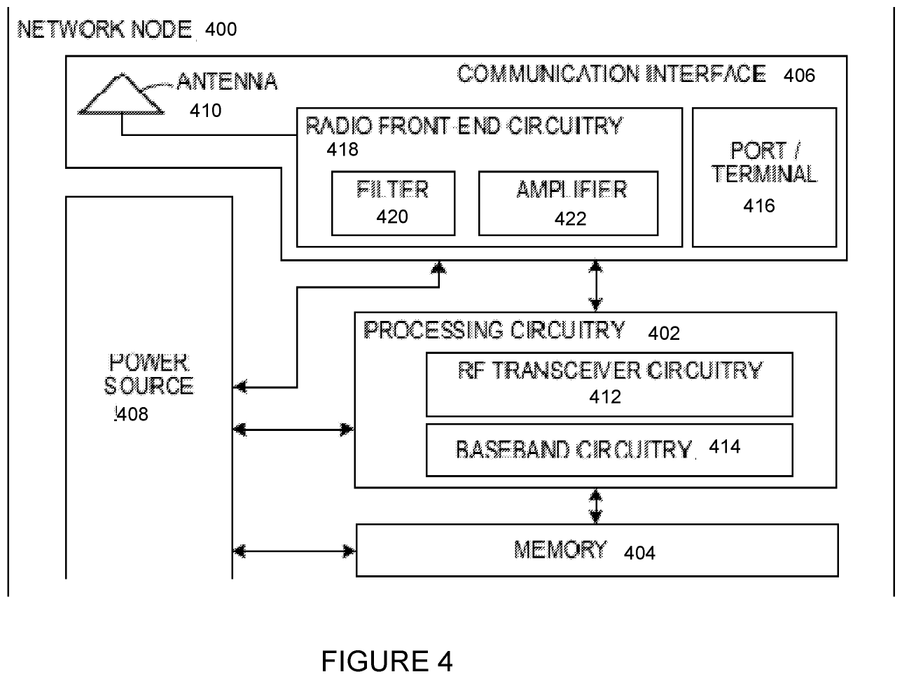

FIG. 4 shows a network node 400 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 400 includes a processing circuitry 402, a memory 404, a communication interface 406, and a power source 408. The network node 400 may be composed of multiple physically separate components (e.g., a NodeB component and a RNC component, or a BTS component and a BSC component, etc.), which may each have their own respective components. In certain scenarios in which the network node 400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 400 may be configured to support multiple radio access technologies (RATs). In such embodiments, some components may be duplicated (e.g., separate memory 404 for different RATs) and some components may be reused (e.g., a same antenna 410 may be shared by different RATs). The network node 400 may also include multiple sets of the various illustrated components for different wireless technologies integrated into network node 400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 400.

The processing circuitry 402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 400 components, such as the memory 404, to provide network node 400 functionality.

In some embodiments, the processing circuitry 402 includes a system on a chip (SOC). In some embodiments, the processing circuitry 402 includes one or more of radio frequency (RF) transceiver circuitry 412 and baseband processing circuitry 414. In some embodiments, the radio frequency (RF) transceiver circuitry 412 and the baseband processing circuitry 414 may be on separate chips (or sets of chips), boards, or units, such as radio units and digital units. In alternative embodiments, part or all of RF transceiver circuitry 412 and baseband processing circuitry 414 may be on the same chip or set of chips, boards, or units.

The memory 404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 402. The memory 404 may store any suitable instructions, data, or information, including a computer program, software, an application including one or more of logic, rules, code, tables, and/or other instructions capable of being executed by the processing circuitry 402 and utilized by the network node 400. The memory 404 may be used to store any calculations made by the processing circuitry 402 and/or any data received via the communication interface 406. In some embodiments, the processing circuitry 402 and memory 404 is integrated.

The communication interface 406 is used in wired or wireless communication of signaling and/or data between a network node, access network, and/or UE. As illustrated, the communication interface 406 comprises port(s)/terminal(s) 416 to send and receive data, for example to and from a network over a wired connection. The communication interface 406 also includes radio front-end circuitry 418 that may be coupled to, or in certain embodiments a part of, the antenna 410. Radio front-end circuitry 418 comprises filters 420 and amplifiers 422. The radio front-end circuitry 418 may be connected to an antenna 410 and processing circuitry 402. The radio front-end circuitry may be configured to condition signals communicated between antenna 410 and processing circuitry 402. The radio front-end circuitry 418 may receive digital data that is to be sent out to other network nodes or UEs via a wireless connection. The radio front-end circuitry 418 may convert the digital data into a radio signal having the appropriate channel and bandwidth parameters using a combination of filters 420 and/or amplifiers 422. The radio signal may then be transmitted via the antenna 410. Similarly, when receiving data, the antenna 410 may collect radio signals which are then converted into digital data by the radio front-end circuitry 418. The digital data may be passed to the processing circuitry 402. In other embodiments, the communication interface may comprise different components and/or different combinations of components.

In certain alternative embodiments, the network node 400 does not include separate radio front-end circuitry 418, instead, the processing circuitry 402 includes radio front-end circuitry and is connected to the antenna 410. Similarly, in some embodiments, all or some of the RF transceiver circuitry 412 is part of the communication interface 406. In still other embodiments, the communication interface 406 includes one or more ports or terminals 416, the radio front-end circuitry 418, and the RF transceiver circuitry 412, as part of a radio unit (not shown), and the communication interface 406 communicates with the baseband processing circuitry 414, which is part of a digital unit (not shown).

The antenna 410 may include one or more antennas, or antenna arrays, configured to send and/or receive wireless signals. The antenna 410 may be coupled to the radio front-end circuitry 418 and may be any type of antenna capable of transmitting and receiving data and/or signals wirelessly. In certain embodiments, the antenna 410 is separate from the network node 400 and connectable to the network node 400 through an interface or port.

The antenna 410, communication interface 406, and/or the processing circuitry 402 may be configured to perform any receiving operations and/or certain obtaining operations described herein as being performed by the network node. Any information, data and/or signals may be received from a UE, another network node and/or any other network equipment. Similarly, the antenna 410, the communication interface 406, and/or the processing circuitry 402 may be configured to perform any transmitting operations described herein as being performed by the network node. Any information, data and/or signals may be transmitted to a UE, another network node and/or any other network equipment.

The power source 408 provides power to the various components of network node 400 in a form suitable for the respective components (e.g., at a voltage and current level needed for each respective component). The power source 408 may further comprise, or be coupled to, power management circuitry to supply the components of the network node 400 with power for performing the functionality described herein. For example, the network node 400 may be connectable to an external power source (e.g., the power grid, an electricity outlet) via an input circuitry or interface such as an electrical cable, whereby the external power source supplies power to power circuitry of the power source 408. As a further example, the power source 408 may comprise a source of power in the form of a battery or battery pack which is connected to, or integrated in, power circuitry. The battery may provide backup power should the external power source fail.

Embodiments of the network node 400 may include additional components beyond those shown in FIG. 4 for providing certain aspects of the network node's functionality, including any of the functionality described herein and/or any functionality necessary to support the subject matter described herein. For example, the network node 400 may include user interface equipment to allow input of information into the network node 400 and to allow output of information from the network node 400. This may allow a user to perform diagnostic, maintenance, repair, and other administrative functions for the network node 400.

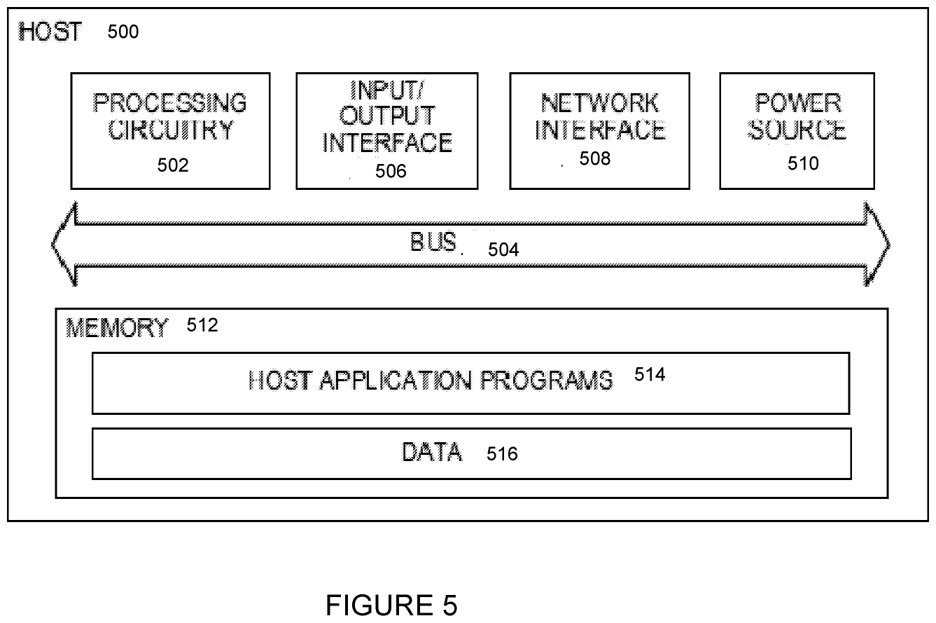

FIG. 5 is a block diagram of a host 500, which may be an embodiment of the host 216 of FIG. 2, in accordance with various aspects described herein. As used herein, the host 500 may be or comprise various combinations hardware and/or software, including a standalone server, a blade server, a cloud-implemented server, a distributed server, a virtual machine, container, or processing resources in a server farm. The host 500 may provide one or more services to one or more UEs.

The host 500 includes processing circuitry 502 that is operatively coupled via a bus 504 to an input/output interface 506, a network interface 508, a power source 510, and a memory 512. Other components may be included in other embodiments. Features of these components may be substantially similar to those described with respect to the devices of previous figures, such as FIGS. 3 and 4, such that the descriptions thereof are generally applicable to the corresponding components of host 500.

The memory 512 may include one or more computer programs including one or more host application programs 514 and data 516, which may include user data, e.g., data generated by a UE for the host 500 or data generated by the host 500 for a UE. Embodiments of the host 500 may utilize only a subset or all of the components shown. The host application programs 514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 514 may also provide for user authentication and licensing checks and may periodically report health, routes, and content availability to a central node, such as a device in or on the edge of a core network. Accordingly, the host 500 may select and/or indicate a different host for over-the-top services for a UE. The host application programs 514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

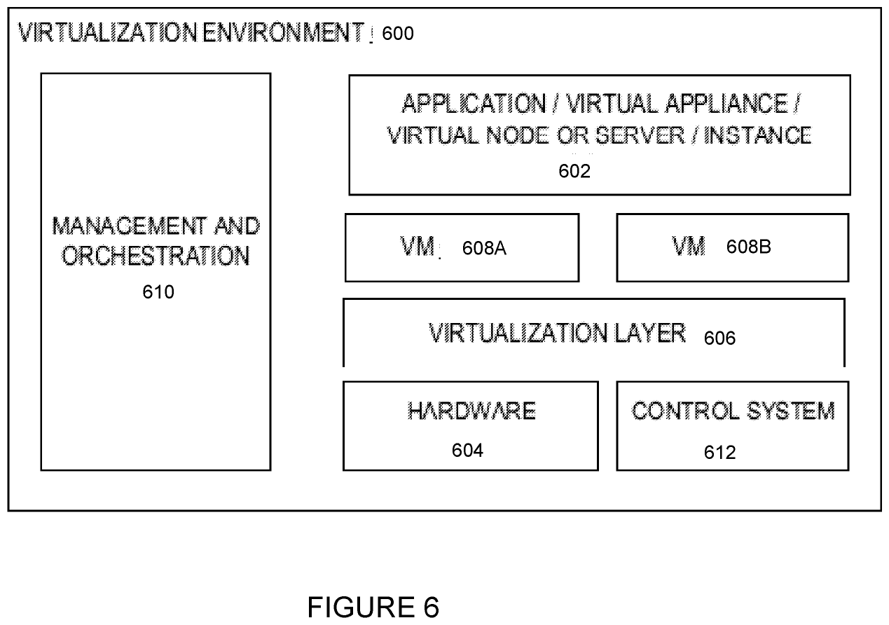

FIG. 6 is a block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 606 (also referred to as hypervisors or virtual machine monitors (VMMs)), provide VMs 608a and 608b (one or more of which may be generally referred to as VMs 608), and/or perform any of the functions, features and/or benefits described in relation with some embodiments described herein. The virtualization layer 606 may present a virtual operating platform that appears like networking hardware to the VMs 608.

The VMs 608 comprise virtual processing, virtual memory, virtual networking or interface and virtual storage, and may be run by a corresponding virtualization layer 606. Different embodiments of the instance of a virtual appliance 602 may be implemented on one or more of VMs 608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 608 may be a software implementation of a physical machine that runs programs as if they were executing on a physical, non-virtualized machine. Each of the VMs 608, and that part of hardware 604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 608 on top of the hardware 604 and corresponds to the application 602.

Hardware 604 may be implemented in a standalone network node with generic or specific components. Hardware 604 may implement some functions via virtualization. Alternatively, hardware 604 may be part of a larger cluster of hardware (e.g. such as in a data center or CPE) where many hardware nodes work together and are managed via management and orchestration 610, which, among others, oversees lifecycle management of applications 602. In some embodiments, hardware 604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 612 which may alternatively be used for communication between hardware nodes and radio units.

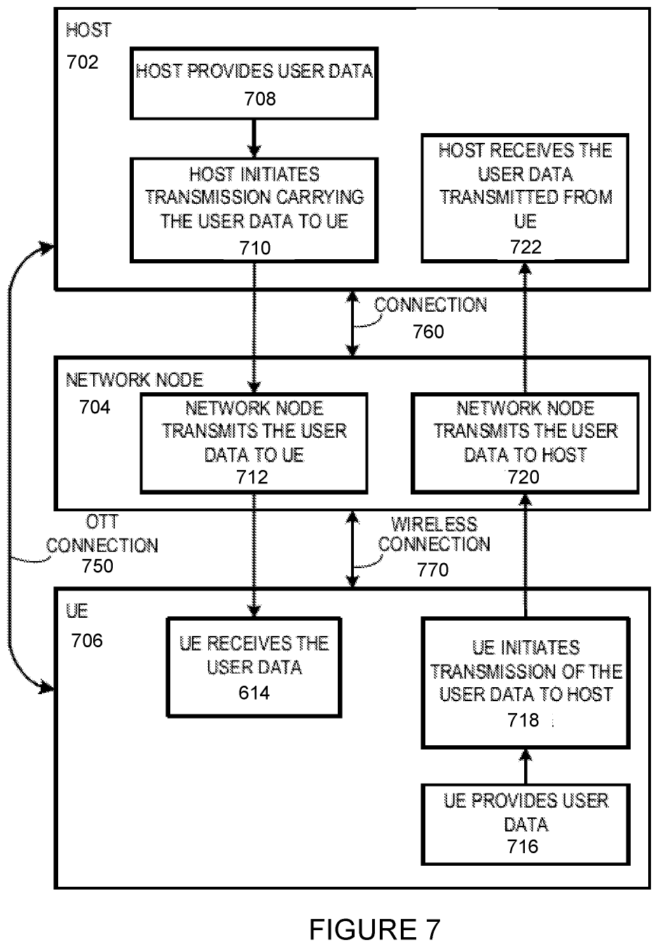

FIG. 7 shows a communication diagram of a host 702 communicating via a network node 704 with a UE 706 over a partially wireless connection in accordance with some embodiments. Example implementations, in accordance with various embodiments, of the UE (such as a UE 212a of FIG. 2 and/or UE 300 of FIG. 3), network node (such as network node 210a of FIG. 2 and/or network node 400 of FIG. 4), and host (such as host 216 of FIG. 2 and/or host 500 of FIG. 5) discussed in the preceding paragraphs will now be described with reference to FIG. 7.

Like host 500, embodiments of host 702 include hardware, such as a communication interface, processing circuitry, and memory. The host 702 also includes software, which is stored in or accessible by the host 702 and executable by the processing circuitry. The software includes a host application that may be operable to provide a service to a remote user, such as the UE 706 connecting via an over-the-top (OTT) connection 750 extending between the UE 706 and host 702. In providing the service to the remote user, a host application may provide user data which is transmitted using the OTT connection 750.

The network node 704 includes hardware enabling it to communicate with the host 702 and UE 706. The connection 760 may be direct or pass through a core network (like core network 206 of FIG. 2) and/or one or more other intermediate networks, such as one or more public, private, or hosted networks. For example, an intermediate network may be a backbone network or the Internet.

The UE 706 includes hardware and software, which is stored in or accessible by UE 706 and executable by the UE's processing circuitry. The software includes a client application, such as a web browser or operator-specific “app” that may be operable to provide a service to a human or non-human user via UE 706 with the support of the host 702. In the host 702, an executing host application may communicate with the executing client application via the OTT connection 750 terminating at the UE 706 and host 702. In providing the service to the user, the UE's client application may receive request data from the host's host application and provide user data in response to the request data. The OTT connection 750 may transfer both the request data and the user data. The UE's client application may interact with the user to generate the user data that it provides to the host application through the OTT connection 750.

The OTT connection 750 may extend via a connection 760 between the host 702 and the network node 704 and via a wireless connection 770 between the network node 704 and the UE 706 to provide the connection between the host 702 and the UE 706. The connection 760 and wireless connection 770, over which the OTT connection 750 may be provided, have been drawn abstractly to illustrate the communication between the host 702 and the UE 706 via the network node 704, without explicit reference to any intermediary devices and the precise routing of messages via these devices.

As an example of transmitting data via the OTT connection 750, in step 708, the host 702 provides user data, which may be performed by executing a host application. In some embodiments, the user data is associated with a particular human user interacting with the UE 706. In other embodiments, the user data is associated with a UE 706 that shares data with the host 702 without explicit human interaction. In step 710, the host 702 initiates a transmission carrying the user data towards the UE 706. The host 702 may initiate the transmission responsive to a request transmitted by the UE 706. The request may be caused by human interaction with the UE 706 or by operation of the client application executing on the UE 706. The transmission may pass via the network node 704, in accordance with the teachings of the embodiments described throughout this disclosure. Accordingly, in step 712, the network node 704 transmits to the UE 706 the user data that was carried in the transmission that the host 702 initiated, in accordance with the teachings of the embodiments described throughout this disclosure. In step 714, the UE 706 receives the user data carried in the transmission, which may be performed by a client application executed on the UE 706 associated with the host application executed by the host 702.

In some examples, the UE 706 executes a client application which provides user data to the host 702. The user data may be provided in reaction or response to the data received from the host 702. Accordingly, in step 716, the UE 706 may provide user data, which may be performed by executing the client application. In providing the user data, the client application may further consider user input received from the user via an input/output interface of the UE 706. Regardless of the specific manner in which the user data was provided, the UE 706 initiates, in step 718, transmission of the user data towards the host 702 via the network node 704. In step 720, in accordance with the teachings of the embodiments described throughout this disclosure, the network node 704 receives user data from the UE 706 and initiates transmission of the received user data towards the host 702. In step 722, the host 702 receives the user data carried in the transmission initiated by the UE 706.

One or more of the various embodiments improve the performance of OTT services provided to the UE 706 using the OTT connection 750, in which the wireless connection 770 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 702. As another example, the host 702 may process audio and video data which may have been retrieved from a UE for use in creating maps. As another example, the host 702 may collect and analyze real-time data to assist in controlling vehicle congestion (e.g., controlling traffic lights). As another example, the host 702 may store surveillance video uploaded by a UE. As another example, the host 702 may store or control access to media content such as video, audio, VR or AR which it can broadcast, multicast or unicast to UEs. As other examples, the host 702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 750 between the host 702 and UE 706, in response to variations in the measurement results. The measurement procedure and/or the network functionality for reconfiguring the OTT connection may be implemented in software and hardware of the host 702 and/or UE 706. In some embodiments, sensors (not shown) may be deployed in or in association with other devices through which the OTT connection 750 passes; the sensors may participate in the measurement procedure by supplying values of the monitored quantities exemplified above, or supplying values of other physical quantities from which software may compute or estimate the monitored quantities. The reconfiguring of the OTT connection 750 may include message format, retransmission settings, preferred routing etc.; the reconfiguring need not directly alter the operation of the network node 704. Such procedures and functionalities may be known and practiced in the art. In certain embodiments, measurements may involve proprietary UE signaling that facilitates measurements of throughput, propagation times, latency and the like, by the host 702. The measurements may be implemented in that software causes messages to be transmitted, in particular empty or ‘dummy’ messages, using the OTT connection 750 while monitoring propagation times, errors, etc.

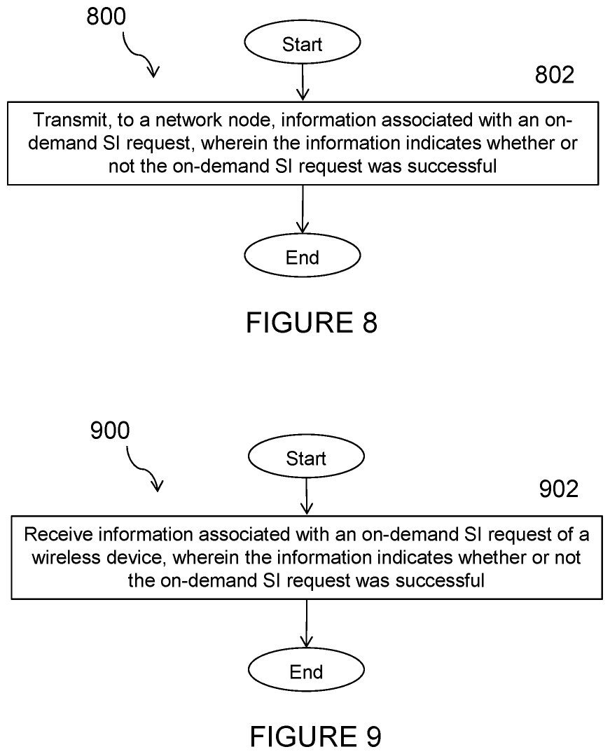

FIG. 8 illustrates a method 800 by a wireless device 212A-D for reporting information associated with an on demand SI/SIB request, according to certain embodiments. The method includes transmitting, to a network node 210A-B, information associated with the on-demand SI/SIB request, at step 802. The information indicates that the on-demand SI request was successful or that the on-demand SI request was not successful.

In a particular embodiment, the information includes an indication of at least one SIB requested by the wireless device 212A-D.

In a particular embodiment, the information indicates whether the wireless device received the at least one SIB requested by the wireless device 212A-D.

In a particular embodiment, the information indicates at least one of: whether or not an acknowledgment for the SI request has been received from a lower layer; that an acknowledgement for the SI request was not received from a lower layer; that an acknowledgement for the SI request was received from a lower layer; whether acquiring at least one SI message has failed while the acknowledgement for the SI request has been received from a lower layer; an indication that the wireless device 212A-D received only a portion of the at least one SI message requested by the wireless device 212A-D; an indication of whether the wireless device 212A-D has checked an SI window for the at least one SI message; an indication of how many SI window occasions has been monitored by the wireless device 212A-D for the at least one SI message; an indication of how many attempts to receive the at least one SI message the wireless device 212A-D performed; a number of HARQ retransmissions the wireless device 212A-D made when transmitting a RRC message to request the at least one SI message; an indication of whether the wireless device 212A-D received acknowledgment from a HARQ procedure at lower layer; location information of the wireless device 212A-D at a time when the wireless device 212A-D transmitted the on-demand SI request; and a cell identifier of a cell in which the on-demand SI request is performed.

In a particular embodiment, the wireless device 212A-D logging the information while performing a SI request procedure associated with transmitting the on-demand SI request.

In a particular embodiment, the information is transmitted in a RA report or RACH report.

In a particular embodiment, the RA report or the RACH report comprises at least one RSRP measurement and/or a pathloss measurement.

In a particular embodiment, the information is transmitted in a report dedicated to the on-demand SI-request.

In a particular embodiment, the wireless device 212A-D is a user equipment.

FIG. 9 illustrates a method by a network node 210A-B for processing information associated with an on-demand SI/SIB request, according to certain embodiments. The method includes receiving information associated with the on-demand SI request of a wireless device 212A-D, at step 902. The information indicates that the on-demand SI request was successful or that the on-demand SI request was not successful.

In a particular embodiment, the information includes an indication of at least one SIB requested by the wireless device 212A-D.

In a particular embodiment, the information indicates whether the wireless device 212A-D received the at least one SIB requested by the wireless device 212A-D.

In a particular embodiment, the information indicates at least one of: whether or not an acknowledgment for the SI request has been received from a lower layer; that an acknowledgement for the SI request was not received from a lower layer; that an acknowledgement for the SI request was received from a lower layer; whether acquiring at least one SI message has failed while the acknowledgement for the SI request has been received from a lower layer; an indication that the wireless device 212A-D received only a portion of the at least one SI message requested by the wireless device 212A-D; an indication of whether the wireless device 212A-D has checked an SI window for the at least one SI message; an indication of how many SI window occasions has been monitored by the wireless device 212A-D for the at least one SI message; an indication of how many attempts to receive the at least one SI message the wireless device 212A-D performed; a number of HARQ retransmissions the wireless device 212A-D made when transmitting a RRC message to request the at least one SI message; an indication of whether the wireless device 212A-D received acknowledgment from a HARQ procedure at lower layer; location information of the wireless device 212A-D at a time when the wireless device 212A-D transmitted the on-demand SI request; and a cell identifier of a cell in which the on-demand SI request is performed.

In a particular embodiment, the information is logged by the wireless device 212A-D while performing an SI request procedure associated with transmitting the on-demand SI request.

In a particular embodiment, the information is received in a RA report or RACH report.

In a particular embodiment, the RA report or the RACH report comprises at least one RSRP measurement and/or a pathloss measurement.

In a particular embodiment, the information is received in a report dedicated to the on-demand SI-request.

In a particular embodiment, the network node 210A-B comprises a radio access node, and the method further comprises forwarding the information to at least an O&M node.

In a particular embodiment, the network node 210A-B comprises an O&M node, and the information is received via a radio access network node in communication with the wireless device 212A-D.

In a particular embodiment, the network node 210A-B optimizes, adapts, tunes, modifies, or changes a configuration for transmitting at least one SI message based on the information.

In a particular embodiment, when optimizing, adapting, tuning, modifying, or changing the configuration for transmitting the at least one SI message based on the information, the network node 210A-B performs at least one of: changing how a plurality of SIBs are grouped into different SI messages; changing whether the at least one SI message is broadcast or not; changing an amount of PRACH resources dedicated for a subsequent on-demand SI request; changing a RA related configuration associated with at least one subsequent on-demand SI request; changing a mapping of at least one RA preamble to at least one subsequent SI message for Msg1; changing from a Msg1 based SI request to a Msg3 based SI request; changing whether at least one SI message is available via Msg1 or Msg3; changing a number of times a subsequent SI message is broadcast; changing a time period for broadcasting a subsequent SI message; changing a scheduling periodicity of subsequent SI messages; changing a number of times an SI message is sent within an associated SI window; changing at least one beam in which a requested SI message is transmitted; changing a mapping between at least one SIB and at least one SI message; and changing a length of an SI window.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a wireless device for logging failure information for On-Demand System Information request procedures includes any of the wireless device steps, features, or functions described above, either alone or in combination with other steps, features, or functions described above.

Example Embodiment A2. The method of the previous embodiment, further comprising one or more additional wireless device steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for processing logged failure information for On-Demand System Information request procedures, the method comprising any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment CL. A method by a wireless device (such as, for example, a user equipment (UE)) for logging failure information for On-Demand System Information request procedures includes transmitting, to a network node, information associated with an on-demand system information (SI) request.

Example Embodiment C2. The method of Example Embodiment C1, wherein the information indicates at least one of: whether or not the on-demand SI request was successful; that the on-demand SI request was successful; that the on-demand SI request was not successful; whether or not an acknowledgment for the SI request has been received from a lower layer (i.e., PHY, MAC, or RLC layer); that an acknowledgement for the SI request was not received from a lower layer; that an acknowledgement for the SI request was received from a lower layer; whether acquiring the SI message has failed while the acknowledgement for the SI request has been received from a lower layer; whether acquiring the SI message has been successful while the acknowledgement for the SI request has not been received from a lower layer; an indication that the wireless device received only a portion of the system information blocks (SIBs) requested; an indication of whether the wireless device has checked an SI window for at least one SI message before sending a preamble; an indication of how many SI window occasions has been monitored by the wireless device for the at least one SI message; an indication of how many attempts to receive a requested SI message the wireless device performed; a number of Hybrid Automatic Repeat Request (HARQ) retransmissions the wireless device made when transmitting a Radio Resource Control (RRC) message to request the SI; an indication of whether the wireless device received acknowledgment from a HARQ procedure at lower layer; an indication of whether the wireless device received the acknowledgement from the Radio Link Control (RLC) lower layer; location information of the wireless device at a time when the wireless device initiated the on-demand SI request; and a cell identifier of a cell in which the on-demand SI request is performed.

Example Embodiment C3. The method of any one of Example Embodiments C1 to C2, wherein the on-demand SI request comprises an on-demand system information block (SIB) request.

Example Embodiment C4. The method of any one of Example Embodiments C1 to C3, further comprising logging the information while performing a SI procedure associated with the on-demand SI request.

Example Embodiment C5. The method of any one of Example Embodiments C1 to C4, wherein the information is transmitted in a Random Access Report or Random Access Channel report.

Example Embodiment C6. The method of any one of Example Embodiments C1 to C4, wherein the information is transmitted in a report dedicated to the on-demand SI-request.

Example Embodiment C7. The method of any one of Example Embodiments C1 to C6, wherein the information further comprises at least one signal strength measurement associated with synchronization signal block beams providing coverage for the wireless device when acquiring the SI.

Example Embodiment C8. The method of any one of Example Embodiment C7, wherein the at least one signal strength measurement comprises at least one of: a RSRP measurement, a RSRQ measurement, a SINR measurement, a SNR measurement, a RSSI measurement, and a pathloss measurement.

Example Embodiment C9. The method of any one of Example Embodiments C1 to C8, further comprising: prior to sending the information to the network node, transmitting an indication to the network node that the information is available; and receiving, from the network node, a request for the information, and wherein the information is transmitted to the network node in response to the request.

Example Embodiment C10. The method of any one of Example Embodiments C1 to C9, wherein the wireless device is a user equipment.

Example Embodiment C11. The method of Example Embodiments C1 to C10, further comprising: providing user data; and forwarding the user data to a host via the transmission to the network node.

Example Embodiment C12. A wireless device comprising processing circuitry configured to perform any of the methods of Example Embodiments C1 to C12.

Example Embodiment C13. A wireless device comprising processing circuitry configured to perform any of the methods of Example Embodiments C1 to C12.

Example Embodiment C14. A computer program comprising instructions which when executed on a computer perform any of the methods of Example Embodiments C1 to C12.

Example Embodiment C15. A computer program product comprising computer program, the computer program comprising instructions which when executed on a computer perform any of the methods of Example Embodiments C1 to C12.

Example Embodiment C16. A non-transitory computer readable medium storing instructions which when executed by a computer perform any of the methods of Example Embodiments C1 to C12.

### Group D Example Embodiments

Example Embodiment D1. A method by a network node for processing logged failure information for On-Demand System Information request procedures includes receiving, from a wireless device, information associated with an on-demand system information (SI) request.

Example Embodiment D2. The method of Example Embodiment D1, wherein the information indicates at least one of: whether or not the on-demand SI request was successful; that the on-demand SI request was successful; that the on-demand SI request was not successful; whether or not an acknowledgment for the SI request has been received from a lower layer (i.e., PHY, MAC, or RLC layer); that an acknowledgement for the SI request was not received from a lower layer; that an acknowledgement for the SI request was received from a lower layer; whether acquiring the SI message has failed while the acknowledgement for the SI request has been received from a lower layer; whether acquiring the SI message has been successful while the acknowledgement for the SI request has not been received from a lower layer; an indication that the wireless device received only a portion of the system information blocks (SIBs) requested; an indication of whether the wireless device has checked an SI window for at least one SI message before sending a preamble; an indication of how many SI window occasions has been monitored by the wireless device for the at least one SI message; an indication of how many attempts to receive a requested SI message the wireless device performed; a number of Hybrid Automatic Repeat Request (HARQ) retransmissions the wireless device made when transmitting a Radio Resource Control (RRC) message to request the SI; an indication of whether the wireless device received acknowledgment from a HARQ procedure at lower layer; an indication of whether the wireless device received the acknowledgement from the Radio Link Control (RLC) lower layer; location information of the wireless device at a time when the wireless device initiated the on-demand SI request; and a cell identifier of a cell in which the on-demand SI request is performed.

Example Embodiment D3. The method of any one of Example Embodiments D1 to D2, wherein the on-demand SI request comprises an on-demand system information block (SIB) request.

Example Embodiment D4. The method of any one of Example Embodiments D1 to D3, wherein the information is logged by the wireless device while performing an SI procedure associated with the on-demand SI request.

Example Embodiment D5. The method of any one of Example Embodiments D1 to D4, wherein the information is received in a Random Access Report or Random Access Channel report.

Example Embodiment D6. The method of any one of Example Embodiments D1 to D4, wherein the information is received in a report dedicated to the on-demand SI-request.

Example Embodiment D7. The method of any one of Example Embodiments D1 to D6, wherein the information further comprises at least one signal strength measurement associated with synchronization signal block beams providing coverage for the wireless device when acquiring the SI.

Example Embodiment D8. The method of any one of Example Embodiment D7, wherein the at least one signal strength measurement comprises at least one of: a RSRP measurement, a RSRQ measurement, a SINR measurement, a SNR measurement, a RSSI measurement, and a pathloss measurement.

Example Embodiment D9. The method of any one of Example Embodiments D1 to D8, further comprising, prior to receiving the information, receiving an indication from the wireless device that the information is available and transmitting, to the wireless device, a request for the information. The information is received by the network node in response to the request.

Example Embodiment D10. The method of any one of Example Embodiments D1 to D9, further comprising forwarding the information to at least one other network node.

Example Embodiment D11. The method of any one of Example Embodiments D1 to D10, further comprising optimizing, adapting, tuning, modifying, or changing a configuration for at least one SI transmission based on the information.

Example Embodiment D12. The method of Example Embodiments D11, wherein optimizing, adapting, tuning, modifying, or changing a configuration for at least one SI transmission based on the information comprises at least one of: changing how SIBs are grouped into different SI messages; changing whether a SIB/SI message is broadcast or not; changing an amount of PRACH resources dedicated for a SI request; changing a RA related configuration associated with at least one SI request; changing a mapping of random access preambles to SI messages for Msg1; changing from Msg1 based to Msg3 based SI request; change which SI messages are available via Msg1 and/or which SI messages are available via Msg3; change a number of times or a time period for broadcasting a SI message; changing a scheduling periodicity of on-demand SI messages; changing a number of times an on-demand SI message is sent within an associated SI window; changing the beams in which a requested SI message is transmitted; changing a mapping between SIBs and SI messages; and changing a length of an SI window.

Example Embodiment D13. The method of any one of Example Embodiments D1 to D12, wherein the wireless device is a user equipment.

Example Embodiment D14. The method of any one of Example Embodiments D1 to D13, wherein the network node comprises a gNodeB (gNB).

Example Embodiment D15. The method of any of the previous Example Embodiments, further comprising obtaining user data and forwarding the user data to a host or a user equipment.

Example Embodiment D16. A network node comprising processing circuitry configured to perform any of the methods of Example Embodiments D1 to D15.

Example Embodiment D17. A computer program comprising instructions which when executed on a computer perform any of the methods of Example Embodiments D1 to D15.

Example Embodiment D18. A computer program product comprising computer program, the computer program comprising instructions which when executed on a computer perform any of the methods of Example Embodiments D1 to D15.

Example Embodiment D19. A non-transitory computer readable medium storing instructions which when executed by a computer perform any of the methods of Example Embodiments D1 to D15.

### Group E Example Embodiments

Example Embodiment E1. A user equipment (UE) for logging failure information for On-Demand System Information request procedures, comprising: processing circuitry configured to perform any of the steps of any of the Group A and C Example Embodiments; and power supply circuitry configured to supply power to the processing circuitry.

Example Embodiment E2. A network node for processing logged failure information for On-Demand System Information request procedures, the network node comprising: processing circuitry configured to perform any of the steps of any of the Group B and D Example Embodiments; power supply circuitry configured to supply power to the processing circuitry.

Example Embodiment E3. A user equipment (UE) for logging failure information for On-Demand System Information request procedures, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1.-42. (canceled)

43. A method by a wireless device for reporting information associated with an on demand System Information, SI, request, the method comprising:
transmitting, to a network node, information associated with the on-demand SI request, wherein the information indicates that the on-demand SI request was successful or that the on-demand SI request was not successful.

44. The method of claim 43, wherein the information comprises an indication of at least one System Information Block, SIB, requested by the wireless device.

45. The method of claim 44, wherein the information indicates whether the wireless device received the at least one SIB requested by the wireless device.

46. The method of claim 43, wherein the information indicates at least one of:
whether or not an acknowledgment for the SI request has been received from a lower layer;
that an acknowledgement for the SI request was not received from a lower layer;
that an acknowledgement for the SI request was received from a lower layer;
whether acquiring at least one SI message has failed while the acknowledgement for the SI request has been received from a lower layer;
an indication that the wireless device received only a portion of the at least one SI message requested by the wireless device;
an indication of whether the wireless device has checked an SI window for the at least one SI message;
an indication of how many SI window occasions has been monitored by the wireless device for the at least one SI message;
an indication of how many attempts to receive the at least one SI message the wireless device performed;
a number of Hybrid Automatic Repeat Request, HARQ, retransmissions the wireless device made when transmitting a Radio Resource Control, RRC, message to request the at least one SI message;
an indication of whether the wireless device received acknowledgment from a HARQ procedure at lower layer;
location information of the wireless device at a time when the wireless device transmitted the on-demand SI request; and
a cell identifier of a cell in which the on-demand SI request is performed.

47. The method of claim 43, further comprising logging the information while performing a SI request procedure associated with transmitting the on-demand SI request.

48. The method of claim 43, wherein the information is transmitted in a Random Access, RA, report or Random Access Channel, RACH, report.

49. The method of claim 48, wherein the RA report or the RACH report comprises at least one RSRP measurement and/or a pathloss measurement.

50. A method by a network node for processing information associated with an on-demand System Information, SI, request, the method comprising:
receiving information associated with the on-demand SI request of a wireless device, wherein the information indicates that the on-demand SI request was successful or that the on-demand SI request was not successful.

51. The method of claim 50, wherein the information comprises an indication of at least one System Information Block, SIB, requested by the wireless device.

52. The method of claim 51, wherein the information indicates whether the wireless device received the at least one SIB requested by the wireless device.

53. The method of claim 50, wherein the information indicates at least one of:
whether or not an acknowledgment for the SI request has been received from a lower layer;
that an acknowledgement for the SI request was not received from a lower layer;
that an acknowledgement for the SI request was received from a lower layer;
whether acquiring at least one SI message has failed while the acknowledgement for the SI request has been received from a lower layer;
an indication that the wireless device received only a portion of the at least one SI message requested by the wireless device;
an indication of whether the wireless device has checked an SI window for the at least one SI message;
an indication of how many SI window occasions has been monitored by the wireless device for the at least one SI message;
an indication of how many attempts to receive the at least one SI message the wireless device performed;
a number of Hybrid Automatic Repeat Request, HARQ, retransmissions the wireless device made when transmitting a Radio Resource Control, RRC, message to request the at least one SI message;
an indication of whether the wireless device received acknowledgment from a HARQ procedure at lower layer;
location information of the wireless device at a time when the wireless device transmitted the on-demand SI request; and
a cell identifier of a cell in which the on-demand SI request is performed.

54. The method of claim 50, wherein the information is logged by the wireless device while performing an SI request procedure associated with transmitting the on-demand SI request.

55. The method of claim 50, wherein the information is received in a Random Access, RA, report or Random Access Channel, RACH, report.

56. The method of claim 55, wherein the RA report or the RACH report comprises at least one RSRP measurement and/or a pathloss measurement.

57. The method of claim 50, further comprising optimizing, adapting, tuning, modifying, or changing a configuration for transmitting at least one SI message based on the information.

58. The method of claim 57, wherein optimizing, adapting, tuning, modifying, or changing the configuration for transmitting the at least one SI message based on the information comprises at least one of:
changing how a plurality of SIBs are grouped into different SI messages;
changing whether the at least one SI message is broadcast or not;
changing an amount of Physical Random Access Channel, PRACH, resources dedicated for a subsequent on-demand SI request;
changing a RA related configuration associated with at least one subsequent on-demand SI request;
changing a mapping of at least one RA preamble to at least one subsequent SI message for Msg1;
changing from a Msg1 based SI request to a Msg3 based SI request;
changing whether at least one SI message is available via Msg1 or Msg3;
changing a number of times a subsequent SI message is broadcast;
changing a time period for broadcasting a subsequent SI message;
changing a scheduling periodicity of subsequent SI messages;
changing a number of times an SI message is sent within an associated SI window;
changing at least one beam in which a requested SI message is transmitted;
changing a mapping between at least one SIB and at least one SI message; and
changing a length of an SI window.

59. A wireless device for reporting information associated with an on-demand System Information, SI, request, the wireless device adapted to:
transmit, to a network node, information associated with the on-demand SI request, wherein the information indicates whether or not the on-demand SI request was successful.

60. The wireless device of claim 59, wherein the information comprises an indication of at least one System Information Block, SIB, requested by the wireless device.

61. A network node for processing information associated with an on-demand System Information, SI, request, the network node adapted to:
receive information associated with the on-demand SI request of a wireless device, wherein the information indicates that the on-demand SI request was successful or that the on-demand SI request was not successful.

62. The network node of claim 61, wherein the information comprises an indication of at least one System Information Block, SIB, requested by the wireless device.
